(19) United States
(12) Patent Application Publication
(10) Pub. No.: US 2026/0111976 A1
(43) Pub. Date: Apr. 23, 2026

(54) SYSTEMS AND METHODS FOR DOMICILE IMPROVEMENT USING MOBILE SENSOR

(71) Applicant: State Farm Mutual Automobile Insurance Company, Bloomington, IL (US)

(72) Inventor: Arsh Singh, Frisco, TX (US)

(73) Assignee: State Farm Mutual Automobile Insurance Company, Bloomington, IL (US)

(21) Appl. No.: 19/042,639

(22) Filed: Jan. 31, 2025

Related U.S. Application Data
(60) Provisional application No. 63/709,154, filed on Oct. 18, 2024.

(51) Int. Cl. G06Q 50/163

(52) U.S. Cl. CPC G06Q 50/163

(57) ABSTRACT

Systems and methods for initiating an action to improve a condition of a domicile may include (1) receiving, from one or more mobile sensors, a plurality of different types of residential data associated with at least one component or space of the domicile, the plurality of different types of residential data collected by the sensors as the sensors move about at least a portion of the domicile; (2) determining, by processing the plurality of different types of residential data using a machine learning model, at least one of a condition or a status of a device or a system of the domicile, the machine learning model trained to establish a correlation between (i) a subset of the different types of residential data, and (ii) at least one of a condition or a status of a device or system; and (3) initiating the action to improve the condition of the domicile.

### CROSS-REFERENCE TO RELATED APPLICATIONS

This application claims priority to and the benefit of U.S. Provisional Patent Application Ser. No. 63/709,154, filed Oct. 18, 2024, which is incorporated herein by reference in its entirety.

### FIELD OF THE INVENTION

The present disclosure generally relates to residential systems. More particularly, in some implementations, the present systems and methods relate to using a residential system to provide residential recommendations that allow individuals to evaluate a condition or status of a system (or component thereof) of their home and/or to make modifications to their home based upon the assessments.

### BACKGROUND

Individuals may assess standard benchmarks or component characteristics (e.g., conditions, statuses, etc.) when evaluating the well-being or integrity of a system (or component thereof) of a home or domicile. For example, an individual may assess the status of an indicator or alarm (e.g., a smoke alarm, a sump pump alarm, etc.) when evaluating the well-being of a system or subsystem of the home (e.g., a fire detection and/or prevention system, a plumbing system, a septic system, a heating, ventilation, and air conditioning system, etc.).

However, obtaining information relevant to assessing the well-being or integrity of a home, or system/subsystem thereof, may be difficult. Further, obtaining information relevant to performing maintenance or modifications to a home, which may impact the home or related systems/subsystems, may also be difficult. In some scenarios, obtaining information relevant to assessing the condition or status of a home (or system/subsystem thereof) and/or information relevant to performing maintenance or modifications to the home may present an encumbrance or be an imposition to an individual or owner associated with the home. As such, conventional techniques may have certain ineffectiveness, inefficiencies, encumbrances, and/or other drawbacks when evaluating the well-being or remaining useful life of residential properties.

### BRIEF SUMMARY

A computer system may be provided that, inter alia, assesses a condition or a status of a residential system (or component thereof) of a domicile, such as to facilitate (i) determining a condition or a status of a device or a system of the domicile, and/or (ii) initiating an action (e.g., generating a recommendation, etc.) for improving a condition of the domicile. For example, a plurality of different types of residential data associated with at least one component or space of a domicile (e.g., a sump pump, a basement, a refrigerator, a kitchen, etc.) may be analyzed (e.g., via a trained machine learning model, etc.) (and with customer or home owner permission and/or authorized consent) to determine a condition (e.g., an operational efficiency condition, etc.) or a status (e.g., an operating status, an alarm status, etc.) associated with a device or a system (or component thereof) of the domicile (e.g., a plumbing system, a septic system, a drainage system, etc.). In certain instances, at least one type of residential data is received (e.g., collected, retrieved, gathered, etc.) via one or more mobile sensors (e.g., a portable robot, a movable robot, a mobile camera, a phone or camera device coupled with a portable robot, a phone or camera coupled with a movable device (for example a vacuum, a drone, etc.), a rover coupled to a releasable drone,), for example based upon an occupancy characteristic of at least one space of the domicile (e.g., while the domicile is unoccupied, while the basement or kitchen of the domicile is unoccupied by an individual, etc.). The different types of residential data may include audio data and/or non-audio data, including, for example, visual data (e.g., images, videos, etc.), temperature data, and/or other suitable data.

In some instances, the computer system may generate a recommendation for improving a condition of the domicile, including a recommended preventative action (e.g., a recommendation to flush a sump pump to potentially prevent future issues associated with a connected plumbing or septic system, etc.), a recommended mitigative action (e.g., a recommendation to replace a leaking refrigerator coupling to prevent additional water from soaking into the floor boards, etc.), and/or another suitable recommended action (e.g., a recommended component to remove, replace, repair, etc.). In certain instances, the computer system may provide the recommendation to the user (e.g., via a user interface, via a mobile device or other computing device, etc.), for example to allow the user to assess the condition or status of a device or a system (or component thereof) of their home, and/or to make modifications (e.g., preventative modifications, mitigative modifications, etc.) to their home based upon the assessments.

In one aspect, a computer-implemented method for initiating an action to improve a condition of a domicile may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another and which may operate as input and/or output devices. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving, from one or more mobile sensors, a plurality of different types of residential data associated with at least one component or space of the domicile (with user or home owner permission and/or authorized consent), the one or more mobile sensors structured to move about at least a portion of the domicile, wherein the plurality of different types of residential data are collected by the one or more mobile sensors as the one or more mobile sensors move about the at least a portion of the domicile; (2) determining, by processing the plurality of different types of residential data using a machine learning model, at least one of a condition or a status of a device or a system of the domicile, and wherein the machine learning model is trained using historical data to establish at least one correlation between (i) a subset of the plurality of different types of residential data and (ii) at least one of a condition or a status associated with the device or the system of the domicile; and/or (3) initiating, using the machine learning model, an action to improve the condition of the domicile using the at least one of the condition or the status associated with the device or the system of the domicile. The computer system may include additional, less, or alternate functionality and/or operations, including that discussed elsewhere herein.

For instance, in certain embodiments, the computer-implemented method may include, such as via one or more processors and/or other electronic components, providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.

In some implementations, each of the plurality of different types of residential data include geolocation information, and the at least one of the condition or the status of the device or the system of the domicile may be determined using the geolocation information. In certain implementations, each of the plurality of different types of residential data may include time information associated with a collection of the residential data, and the at least one of the condition or the status of the device or the system of the domicile may be determined using the time information.

In certain implementations, the plurality of different types of residential data may include a first type of residential data and second type of residential data. The first type of residential data may include audio data associated with an audio characteristic of the at least one component or space. In some embodiments, the second type of residential data may include non-audio data, and the machine learning model may be trained using the historical data to establish a correlation between (i) the first type of residential data and the second type of residential data, and (ii) the condition or the status associated with the device or the system of the domicile.

Additionally or alternatively, the first type of residential data is collected by a first mobile sensor of the one or more mobile sensors as the first mobile sensor moves about a first portion of the domicile, and/or the second type of residential data is collected by a second mobile sensor of the one or more mobile sensors as the second mobile sensor moves about a second portion of the domicile. In some implementations, the first mobile sensor may be movable robot (such as a rover or other land-movement-based robot) and the second mobile sensor may be a drone (or other air-movement-based robot), and/or the first portion of the domicile may be on a first level of the domicile and the second portion of the domicile may be on a second level of the domicile different than the first level (such as above or below the first level).

In some embodiments, the plurality of different types of residential data may be associated with a space of the domicile. For instance, the space may be a kitchen of the domicile. In certain embodiments, the plurality of different types of residential data may include a first type of residential data, and the first type of residential data may include motion data associated with a space of the domicile. The computer-implemented method may include, such as via one or more processors and/or other electronic components, determining, using the first type of residential data, that the space of the domicile is unoccupied, and the second type of residential data may be received in response to the determination that the space of the domicile is unoccupied.

In certain implementations, the at least one of a condition or a status of the device or system may be an operating condition of a sump pump (or other electronic or electrical component/device). In some implementations, the computer-implemented method may include, such as via one or more processors and/or other electronic components, generating a recommendation for improving the condition of the domicile, the recommendation including at least one of a preventative action, a mitigative action, a component to add to a system of the domicile, or a component to replace in the system of the domicile.

Additionally or alternatively, the computer-implemented method may include, such as via one or more processors and/or other electronic components, (i) receiving residential modification data, the residential modification data including information associated with a modification to the device or the system of the domicile; and/or (ii) comparing the residential modification data with the action instruction to verify a recommendation for improving the condition of the domicile. The computer-implemented method may include, such as via one or more processors and/or other electronic components, (i) generating, based upon the verification of the recommendation for improving the condition of the domicile, at least one insurance policy parameter; and/or (ii) providing the at least one insurance policy parameter via a user interface.

In another aspect, a computer system for initiating an action to improve a condition of a domicile may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receiving, from one or more mobile sensors, a plurality of different types of residential data associated with at least one component or space of the domicile, the one or more mobile sensors structured to move about at least a portion of the domicile, wherein the plurality of different types of residential data include a first type of residential data and a second type of residential data, wherein at least one of the first type of residential data or the second type of residential data is collected by the one or more mobile sensors as the one or more mobile sensors move about the at least a portion of the domicile, and the other of the first type of residential data or the second type of residential data includes audio data associated with an audio characteristic of the at least one component or space; (2) determining, by processing the plurality of different types of residential data using a trained machine learning model, at least one of a condition or a status of a device or a system of the domicile; and/or (3) initiating, using the trained machine learning model, the action to improve the condition of the domicile using the at least one of the condition or the status associated with the device or the system of the domicile. The computer system may include additional, less, or alternate functionality and/or operations, including that discussed elsewhere herein.

For instance, in certain embodiments, the functionality and/or operations may include providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.

In some implementations, each of the plurality of different types of residential data may include geolocation information, and/or the at least one of the condition or the status of the device or the system of the domicile is determined using the geolocation information. In certain implementations, each of the plurality of different types of residential data may include time information associated with a collection of the residential data, and/or the at least one of the condition or the status of the device or the system of the domicile may be determined using the time information.

In another aspect, a non-transitory computer readable medium having instructions stored thereon that, when executed by one or more processors, cause the one or more processors to perform various functionality and operations. For instance, the functionality and operations may include or direct (1) receiving, from one or more mobile sensors, a plurality of different types of residential data associated with at least one component or space of a domicile, the one or more mobile sensors structured to move about at least a portion of the domicile, wherein the plurality of different types of residential data including a first type of residential data and a second type of residential data different from the first type of residential data, wherein at least one of the first type of residential data or the second type of residential data may be collected by the one or more mobile sensors as the one or more mobile sensors move about the at least a portion of the domicile; (2) determining, by processing the plurality of different types of residential data using a trained machine learning model, at least one of a condition or a status of a device or a system of the domicile, and wherein the trained machine learning model may be trained using historical residential data to establish at least one correlation between (i) the first type of residential data and the second type of residential data and (ii) a condition or a status associated with the device or the system of the domicile; and/or (3) initiating, using the trained machine learning model, an action to improve the condition of the domicile using the at least one of the condition or the status associated with the device or the system of the domicile. The instructions may direct additional, less, or alternate functionality, including that discussed elsewhere herein.

For instance, in certain embodiments, the functionality and/or operations may include providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary residential services computer system, according to some embodiments.

FIG. 2 is a block diagram of an exemplary computer residential system, according to some embodiments.

FIG. 3 is a flow diagram of an exemplary computer-implemented or computer-based process of providing an action instruction based upon an assessment of a condition or a status of a device or a system of a domicile, according to some embodiments.

FIG. 4 is a depiction of an exemplary user interface including a recommendation to improve a condition of a domicile, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, systems, methods, and computer-readable storage media for determining a condition or a status of a component or subsystem of a domicile (e.g., a sump pump, etc.). Certain implementations may generate a recommendation for improving a condition of the domicile, which may be utilized, for example, to implement a preventative and/or mitigative action to reduce and/or prevent potential damage, potential inefficient operating conditions, and/or potential health and/or safety risks associated with a potential failure and/or potential damage to the domicile. For instance, one or more mobile sensors (e.g., a portable robot, a movable robot, a portable/movable rover and detachable drone combination, a mobile camera, a camera or phone coupled with a movable device, for example a vacuum, a drone, etc.) may be implemented to obtain (e.g., collect, receive, generate, gather, etc.) different types of residential data, for example as the one or more sensors moves about one or more spaces in a domicile (e.g., a kitchen, a living room, a basement, a crawl space, etc.). For example, the one or more mobile sensors (e.g., portable robot or rover, movable camera or phone coupled with a movable device, for example a vacuum, a drone, etc.) may be implemented to obtain (e.g., collect, receive, etc.) residential data as the sensor moves within a space sometimes inaccessible by a user (e.g., a small or confined space, for example a crawl space, a vent, a closet, etc.), moves within a space when a user is not present (e.g., when the user is at work or away, etc.), and/or moves between different spaces of a home (e.g., between a kitchen, living room, basement, garage, different floors or levels of the home, etc.). Advantageously, the systems and methods described herein may implement one or more mobile sensors (e.g., a portable robot, a camera or phone coupled with a movable device, for example a vacuum, a drone, a rover with wheels and/or coupled drone with wings or rotors, etc.), for example to obtain (e.g., collect, determine, receive, etc.) residential data throughout a home that would otherwise be difficult to obtain, otherwise inaccessible to a user, and/or not traditionally associated in assessing conditions of systems and/or components of a residential building.

In certain instances, the different types of residential data may be analyzed (e.g., using a trained machine learning model, etc.), for example to estimate a condition or a status of a device or system of a domicile (e.g., an operating efficiency of a sump pump, an operating status of a sump pump, etc.). In response to determining the condition or status of the device or system of the domicile, an action may be initiated (e.g., a recommendation may be provided, a corrective action implemented, etc.). For example, a recommendation for improving the a condition of the domicile be generated and/or presented to a user, such as on a user mobile device, AR glasses, VR headset, and/or other computing device, including a recommended action (e.g., a maintenance action to perform on the sump pump, a component to add to the sump pump, a component to remove from the sump pump, a component to replace in the sump pump, and/or another suitable action).

Advantageously, the example features described herein use a trained machine learning model and different types of residential data (e.g., data which is otherwise inaccessible, data which is otherwise difficult or burdensome to obtain, and/or data which is not traditionally correlated and/or associated, etc.) to determine a condition or a status associated with a device or system of the domicile. The condition or status (e.g., an operating efficiency condition, an operating status of a device, etc.) may be utilized, for example, to implement one or more preventative and/or mitigative actions (e.g., a maintenance and/or modification action, etc.) to reduce and/or prevent potential damage to components or spaces of the domicile (e.g., a sump pump, a basement, a refrigerator, a kitchen, etc.), thereby reducing resource consumption associated with the potential damage (e.g., water, electrical, and/or energy consumption associated with operating a damaged component, financial resources associated with repairing and/or replacing damaged components, etc.).

Further, the condition or status may be utilized, for example, to implement one or more preventative and/or mitigative actions (e.g., a maintenance, corrective, and/or modification action, etc.) to reduce and/or prevent potential inefficient operating conditions of a component of the domicile, thereby also reducing resource consumption associated with the inefficient operating conditions (e.g., water, electrical, and/or energy consumption, etc.). In addition, the determined condition or status may advantageously be utilized, for example, to implement a preventative and/or mitigative action (e.g., a maintenance and/or modification action, etc.) to reduce potential health and/or safety risks associated with a potential failure and/or potential damage to the domicile. For example, the condition or status may be utilized to implement an action to reduce health and/or safety risks associated with a potential detectable event (e.g., a potential flooding event, a potential leaking event, a potential fire event, etc.) and/or an undetectable event (e.g., potential exposure to bacteria or mold, or rotting or erosive conditions associated with a flooding or leaking event, potential exposure to harmful gasses associated with a fire or chemical leaking event, etc.).

As an illustrative example, an individual may reference an alarm when evaluating the condition or status of a sump pump of the home (e.g., an operating efficiency or operating status, etc.), for example because the sump pump is difficult to access (e.g., in a basement or crawl space, etc.), difficult to evaluate on their own, and/or difficult to examine. However, the absence of an alarm may not be indicative of all the potential issues associated with the sump pump and/or other associated (e.g., connected, related, etc.) components or spaces (e.g., a dishwasher located in the kitchen, etc.). For example, the characteristics (e.g., age, operating conditions, operating efficiencies, etc.) of the sump pump may impact other components and/or spaces of the domicile (e.g., components of a plumbing or a septic system, a moisture or water level in the basement, etc.). Further, in some instances, the characteristics of the sump pump may potentially impact the individual and/or the home, for example by failing earlier than anticipated and/or operating at less than optimal operating conditions without the homeowner's knowledge, which may potentially lead to damage to the home (e.g., flooding of the basement, etc.) and/or potential injury to the individual (e.g., health and/or safety issues associated with flooded areas of the home, etc.).

Advantageously, the systems and methods described herein may be used to assess (e.g., monitor, evaluate, etc.) the impact of different types of residential information (e.g., data which is otherwise inaccessible, difficult or burdensome to obtain, and/or data not traditionally correlated and/or associated, etc.) on the condition or status of one or more devices or systems of a domicile (e.g., a sump pump, etc.). For example, the systems and methods described herein may utilize one or more mobile sensors (e.g., a portable robot, a movable robot, a drone, a camera or phone coupled with a movable robot, etc.) to collect and/or assess various types of residential data (e.g., audio data associated with an operating state of a fan, visual and/or audio data associated with an alarm of a septic system, etc.), for example to determine a condition or a status associated with a device or system of the domicile (e.g., an operating status of the sump pump, etc.).

Advantageously, the systems and methods described herein may utilize one or more mobile sensors (e.g., a portable or movable robot, a drone, a camera coupled with a movable robot or device, for example a vacuum, etc.), for example to selectively (e.g., automatically, in accordance with a schedule, based upon an occupancy characteristic of a home, in accordance with an instruction, etc.) collect residential information (e.g., which would otherwise be difficult or burdensome to obtain, etc.), which may be used to assess a condition or a status of an associated system, device, and/or space of the domicile (e.g., a sump pump, a refrigerator, a basement, a kitchen, etc.). Further, the systems and methods described herein may initiate an action (e.g., generate and/or provide recommendations, etc.) for preventative and/or mitigative measures (e.g., replacing the sump pump, adding a backup pump, adding a pump with advanced features such as data connectively and/or remote monitoring/alerting, etc.), thereby allowing an individual to reduce and/or prevent potential damage to their home (e.g., prevent a flooding event, etc.), inefficient operating conditions of the sump pump, and/or to reduce potential health and/or safety risks associated with a potential failure of the sump pump, as described herein.

It should be understood that while the computer system is described herein as being associated with a system/component thereof and/or a space of a domicile (e.g., a sump pump in a basement, a refrigerator in a kitchen, etc.), it is contemplated that in some instances the computer system is associated with another suitable residential building (e.g., an apartment complex, an apartment, etc.), another residential system (e.g., electrical system, lighting system, fire detection system, security system, etc.), a component of a residential system or subsystem (e.g., kitchen sink, toilet, dishwasher, etc.), and/or a combination thereof.

### Overview

Referring to the Figures, computer systems and computer-implemented methods for assessing a condition or a status of a residential system (or component thereof) of a domicile, such as to facilitate (i) determining a condition or a status of a device or a system of the domicile, and/or (ii) initiating an action (e.g., generating a recommendation, etc.) for improving a condition of the domicile. Advantageously, the systems and computer-implemented methods described herein may utilize one or more mobile sensors (e.g., a portable robot, a movable robot, a drone, a camera or phone coupled with a movable robot, etc.) to collect and/or assess various types of residential data (e.g., audio data, non-audio data, including, for example, visual data, temperature data, motion data, occupancy data, etc.), for example to determine a condition or a status associated with a device or system of the domicile (e.g., an operating status of the sump pump, etc.). The systems and computer-implemented methods described here may be utilized to initiate an action (e.g., generate and/or provide a recommendation, etc.), for example for preventative and/or mitigative measures (e.g., replacing the sump pump, adding a backup pump, adding a pump with advanced features such as data connectively and/or remote monitoring/alerting, etc.), thereby allowing an individual to reduce and/or prevent potential damage to their home (e.g., prevent a flooding event, etc.), inefficient operating conditions of the sump pump, and/or to reduce potential health and/or safety risks associated with a potential failure of the sump pump, as described herein.

For instance, a trained machine learning model and different types of residential data (e.g., data which is otherwise inaccessible, data which is otherwise difficult or burdensome to obtain, and/or data which is not traditionally correlated and/or associated, etc.) may be used to determine a condition or a status associated with a device or system of the domicile. The condition or status may be utilized, for example, to implement one or more preventative and/or mitigative actions to reduce and/or prevent potential damage to components or spaces of the domicile (e.g., a sump pump, a basement, a refrigerator, a kitchen, etc.), thereby reducing resource consumption associated with the potential damage (e.g., water, electrical, and/or energy consumption associated with operating a damaged component, financial resources associated with repairing and/or replacing damaged components, etc.). Further, the condition or status may be utilized, for example, to implement one or more preventative and/or mitigative actions to reduce and/or prevent potential inefficient operating conditions of a component of the domicile, thereby also reducing resource consumption associated with the inefficient operating conditions (e.g., water, electrical, and/or energy consumption, etc.). In addition, the determined condition or status may advantageously be utilized, for example, to implement a preventative and/or mitigative to reduce potential health and/or safety risks associated with a potential failure and/or potential damage to the domicile, as described herein.

### Exemplary Residential Services System With Residential System

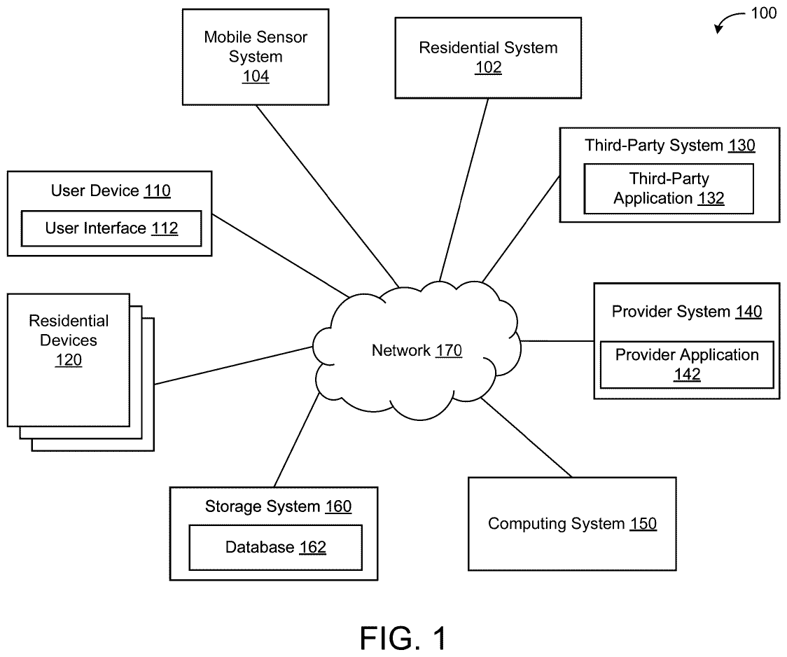

Referring to FIG. 1, a block diagram of an example residential services computer system, shown as residential services system 100, is shown, according to some embodiments. The residential services system 100 may include a computer system, shown as residential system 102, a mobile sensor or mobile sensor system, shown as mobile sensor system 104, a user device 110 having a user interface 112, and at least one residential device, shown as residential devices 120. The residential services system 100 may also include a third-party system 130 having a third-party application 132, a provider system 140 having a provider application 142, and a computing system 150. The residential services system 100 may also include a storage system 160 having a database 162. The components of the residential services system 100 may be connected, or in wired or wireless communication, via a network 170. It should be noted that the number and type of components shown is merely illustrative and, in various embodiments, implementations of the residential services system 100 may have additional, fewer, and/or different components than those illustrated in FIG. 1, including those mentioned elsewhere herein. Further, it should be noted that the features and functionalities described herein are merely illustrative and, in various embodiments, the features and functionalities of one or more components of the residential services system 100 may be implemented (e.g., executed, performed, realized, applied, etc.) using any of, or combination of, components of the residential services system 100 described elsewhere herein.

As will be discussed in detail below, the residential system 102 may be configured to determine a condition or a status of a system, a subsystem, and/or a component of a domicile, and/or initiate an action (e.g., provide a recommendation, such as visually or audibly, via one or more computing devices) for improving a condition of the domicile. For example, the residential system 102 may receive a plurality of different types of residential data associated with at least one component or space of a domicile. In some implementations, the residential system 102 may receive residential data from one or more sensors (e.g., a mobile sensor, a movable robot, a portable robot, a camera coupled with a movable device, for example a vacuum, a drone, etc.), for example as one or more mobile sensors move about at least a portion of the domicile (e.g. a kitchen, a living room, a basement, between several levels or floors of the domicile, etc.). The residential system 102 may assess the plurality of different types of residential data and determine a condition or a status of a device or a system of the domicile. In certain embodiments, the residential system 102 is configured to generate a recommendation for improving a condition of the domicile, for example based upon the determined condition or status of the device or the system. The recommendation may include, for example, a recommended maintenance action, a recommended component to add/remove to/from the domicile, and/or a recommended component to replace in the domicile.

According to certain embodiments, components of the residential services system 100 may be configured to communicate (e.g., via the network 170). For example, components of the residential services system 100 may be configured to communicate with the residential system 102. Information and/or data associated with the mobile sensor system 104, the user device 110, and/or the residential devices 120 may be communicated to the residential system 102 (e.g., via the network 170). Information and/or data associated with the third-party system 130, the provider system 140, the computing system 150, and/or the storage system 160 may also be communicated to the residential system 102 (e.g., via the network 170).

In some embodiments, the residential system 102 may be implemented using cloud computing services. The residential system 102 may be implemented using one or more computing devices, for example operating alone and/or in combination. The residential system 102 may be implemented using computing architectures like multiple distributed servers, and/or similar computing devices and/or systems. The residential system 102 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the residential system 102 may be configured to communicate with the mobile sensor system 104. In some implementations, the mobile sensor system 104 may be or include one or more sensors (e.g., mobile sensors, movable sensors, portable sensors, etc.), which may be configured to collect (e.g., gather, determine, etc.) one or more types of residential data. The residential system 102 may be configured to receive (e.g., automatically, in response to an input, etc.) the one or more types of residential data from the mobile sensor system 104, for example in real-time or near real-time. As will be described herein, the mobile sensor system 104 may be configured to collect residential data, for example as the mobile sensor system 104 (e.g., the one or more sensors, etc.) moves about at least a portion of a domicile, where the residential data may be used to determine at least one of a condition or a status of a device or a system of the domicile, and/or which may be used to provide a recommendation for improving a condition of the domicile.

In some implementations, the mobile sensor system 104 is or includes a movable system or device. For example, the mobile sensor system 104 may by an automated system or device that includes one or more wheels, wings, joints, actuators, motors, etc., for example to permit the mobile sensor system 104 to traverse one or more spaces about a domicile (e.g., one or more rooms or spaces, one or more levels or floors, an interior or exterior of the domicile, etc.). In some implementations, the mobile sensor system 104 may be or include a portable robot, a movable robot, and/or another movable device. For example, the mobile sensor system 104 may include a camera or sensor (e.g., a phone, etc.) coupled with a portable device (e.g., a portable robot, a movable device, for example a vacuum, etc.). The mobile sensor system 104 may be or include a drone or UAV (unmanned aerial vehicle), for example to permit the mobile sensor system 104 to move (e.g., fly, etc.) about the domicile.

In certain implementations, the drone may be used, for example, to fly around a house and inspect items like the roof (e.g., shingle condition, etc.) and/or potential hazards near the house such as overhanging trees or trees proximate enough to the house to potentially damage the house if they fell, such as in a high wind condition. The mobile sensor system 104 may include one or more wheels, rollers, tracks, etc., (for instance with a ground-based mobile rover type of device or robot), for example to permit the mobile sensor system 104 to move (e.g., roll, drive, etc.) about the domicile. The mobile sensor system 104 may be configured to move about an interior of the domicile, an exterior of the domicile, and/or within one or more predetermined areas or spaces of the domicile (e.g., about predetermined or set rooms or spaces of a domicile, between one or more rooms, between one or more levels or floors, between an interior and an exterior of the domicile, etc.). For instance, a virtual map of the domicile may be stored in a memory (with or without one or more pre-programmed travel plans about the domicile) for which the mobile sensor system 104 may follow in order to acquire sensor data.

In certain implementations, the mobile sensor system 104 may be a stationary system or device, which may be coupled with a movable system or device (e.g., mounted to a movable device, for example a vacuum, etc.) and/or which may be configured to be movable (e.g., movable via a user or operator, movable via another system or device, etc.).

As described herein, the mobile sensor system 104 may include one or more sensors, which may be used to collect one or more types of residential data. For example, the mobile sensor system 104 may include one or more cameras or visual sensors (e.g., a smart camera, an area scan camera, a line scan camera, a three-dimensional vision camera, a thermal vision camera, a hyperspectral camera, a light detection and ranging (LIDAR) sensor, etc.) and/or one or more microphones or acoustic sensors (e.g., piezoelectric transducers, ultrasonic sensors, acoustic emissions sensors, etc.), for example to collect one or more types of audiovisual data (e.g., images, pictures, videos, voice records, audio records, and/or any other suitable type of audio or visual data or information).

In some implementations, the mobile sensor system 104 may include one or more light or occupancy sensors, for example to collect occupancy data associated with one or more spaces or rooms of a domicile. In certain implementations, the mobile sensor system 104 may include another suitable type of sensor (e.g., temperature sensor, optical sensor, pressure sensor, accelerometer, gyroscope, humidity sensor, light sensor, photoelectric sensor, color sensor, proximity sensor, motion sensor, gas sensor, etc.), for example to collect any other suitable types of residential data associated with a system and/or space of a domicile (e.g., temperature information, light information, motion information, gas information, etc.). In this regard, the mobile sensor system 104 may include one or more sensors, which may be used to collect one or more types of residential data, which may include audio data and/or non-audio data (e.g., visual data, temperature data, light information, motion information, gas information, etc.).

In certain implementations, the mobile sensor system 104 may include a plurality of systems, devices, and/or sensors. For example, the mobile sensor system 104 may include a first movable system or device (e.g., a movable or portable robot, a camera or phone coupled with a movable device, for example a vacuum, etc.) and/or a second movable system or device (e.g., a drone, etc.).

Each of the plurality of systems, devices, and/or sensors may be configured to obtain (e.g., collect, determine, etc.) different types of residential data. For example, the first movable system (e.g., a movable or portable robot, a camera or phone coupled with a movable device, for example a vacuum, etc.) may be configured to collect residential data (e.g., audiovisual data, etc.) as the first movable system moves about a first space in the domicile (e.g., a kitchen, etc.). Further, the second movable system (e.g., a drone, etc.) may be configured to collect residential data (e.g., audiovisual data, etc.) as the second movable system moves about a second space in the domicile (e.g., a basement, etc.).

In certain implementations, the mobile sensor system 104 may be configured to collect (e.g., obtain, receive, etc.) residential data continuously and/or at predetermined times (e.g., under predetermined conditions or scenarios, etc.). For example, the mobile sensor system 104 may be configured to continuously collect residential data based upon a schedule (e.g., during a scheduled period, for example when the owner of the domicile is at work, etc.). The mobile sensor system 104 may be configured to collect residential data associated with a predetermined space (e.g., a bedroom, a bathroom, etc.), for example only in response to a user input (e.g., a user approving the collection of data, for example when the user is not present in the space, etc.). In other implementations, the mobile sensor system 104 may be configured to move about at least a portion of a domicile to collect a first type of residential data (e.g., information associated with an occupancy of a space, or living room, of the domicile, etc.), and based upon the first type of residential data (e.g., a determination that the space is unoccupied, etc.), the mobile sensor system 104 may be configured to collect a second type of residential data (e.g., audio or visual data associated with the living room, etc.). In this regard, the mobile sensor system 104 may be controllable to selectively collect (or not collect) residential data.

In certain embodiments, one or more components of the mobile sensor system 104 (e.g., the plurality of systems, devices, and/or sensors) may be configured to obtain residential data simultaneously (or substantially simultaneously, etc.), in a sequential order or process, and/or at any other suitable time or times. For example, a first movable system or device (e.g., a movable or portable robot, a camera or phone coupled with a movable device, for example a vacuum, etc.) may be configured to collect residential data in a first space (e.g., a kitchen, etc.), for example based upon a schedule (e.g., when a user or occupant is scheduled to be at work or away, etc.). In some embodiments, based upon the residential data obtained by the first movable system or device, a second movable system or device (e.g., a drone, etc.) may be implemented (e.g., controlled, instructed, deployed, etc.) to collect residential data in a second space (e.g., a video of a space in the basement, an image of the sump pump in the crawl space, etc.), for example to be used in determining a condition or a status of a system, device, and/or space of the domicile, as described herein.

In some implementations, the mobile sensor system 104 may be configured to obtain (e.g., collect, receive, determine, etc.) residential data based upon (e.g., using, in accordance with, etc.) one or more controls and/or instructions. For example, and as described herein, the mobile sensor system 104 may be configured to communicate with the residential system 102. In certain scenarios, the mobile sensor system 104 may receive and/or implement one or more controls (e.g., commands, instructions, etc. received from the residential system 102, etc.), for example to selectively control operation of the mobile sensor system 104.

In some embodiments, the one or more controls (e.g., commands, instructions, etc.) may be configured to control a time the mobile sensor system 104 moves about a portion of the domicile. For example, the instructions may control the mobile sensor system 104 to move about the domicile each weekday between 9 AM and 10 AM (e.g., according to a schedule, etc.). Further, the instructions may control one or more locations to which the mobile sensor system 104 is configured to move. For example, the instructions may control the mobile sensor system 104 to move about the kitchen (e.g., but prevent the mobile sensor system 104 from moving into the bedroom or bathroom, etc.).

In some implementations, the instructions may control one or more times at which the mobile sensor system 104 collects data while moving through the domicile. For example, the instructions may control the mobile sensor system 104 to move about the domicile (e.g., living room, kitchen, den, etc.), but only obtain residential data between 1 PM and 2 PM on Mondays, Wednesdays, and Fridays (e.g., when an occupant is away, or working out, etc.).

In certain implementations, the instructions may control one or more locations at which the mobile sensor system 104 collects data while moving through the domicile. For example, the instructions may control the mobile sensor system 104 to collect residential data while the mobile sensor system 104 moves through the living room or kitchen, but not to collect data when the mobile sensor system 104 moves into the bedroom or bathroom (e.g., absent an input or approval from a user or operator, etc.).

In some implementations, the mobile sensor system 104 and the residential system 102 may be configured to communicate in an iterative process (e.g., sequential, periodic, etc.). For example, in certain implementations the mobile sensor system 104 may be configured to obtain residential data in a first space (e.g., obtain audiovisual data associated with a kitchen of the home, etc.), for example based upon an indication that a user or occupant has left the home (e.g., to go to work, etc.). The mobile sensor system 104 may obtain residential data and/or communicate the residential data to the residential system 102, as described herein. In some scenarios, based upon the residential data (e.g., an analysis of or processing of the residential data, as described herein, etc.), the mobile sensor system 104 (e.g., a second device, for example a drone) may receive an instruction (e.g., from the residential system 102, etc.), for example to obtain residential data in a second space (e.g., obtain audiovisual data associated with a basement of the home, etc.). In this regard, in some embodiments, the mobile sensor system 104 may be controllable (e.g., automatically, using one or more controls or instructions, for example received from the residential system 102, etc.), for example to controllably collect different types of residential data associated with one or more systems, devices, and/or spaces of the domicile.

In certain implementations, the mobile sensor system 104 may be configured to obtain (e.g., collect, receive, determine, etc.) different types of residential data, as well as additional information. For example, the mobile sensor system 104 may be configured to obtain residential data, as well as time or temporal information (e.g., a time stamp, etc.) associated with the residential data (e.g., when the residential data is obtained, etc.). Further, the mobile sensor system 104 may be configured to obtain residential data, as well as geolocation and/or telematics information (e.g., a location or space in the domicile) associated with the residential data (e.g., a location where the residential data is obtained, etc.). Advantageously, and as will be described herein, the mobile sensor system 104 may be configured to obtain residential data, as well as different types of information (e.g., time information, location information, home telematic information, etc.), which may be used in determining a condition or status of a system, device, and/or space of a domicile.

As will be discussed herein, the mobile sensor system 104 may be configured to collect a plurality of different types of residential data, which may be used to determine a condition or a status of a device or a system of the domicile. For example, using audio data collected by the mobile sensor system 104 (e.g., a portable or movable robot, a camera coupled with a movable device, for example a vacuum, a drone, etc.), it may be determined that a fan in a basement of the domicile is operating (e.g., is running, is on, etc.). This may, for example, be useful for determining the fan is operating when it should not be operating or is not operating when it should be. Further, using visual data (e.g., a video, an image, etc.) collected by the mobile sensor system 104 (e.g., the portable or moveable robot, a drone, etc.), it may be determined that a circuit has been tripped in the basement of the domicile. Advantageously, using this data collected by the mobile sensor system 104 (e.g., the audio data associated with the fan, the visual data associated with the circuit breaker, etc.), it may be determined that a dehumidifier in the basement (e.g., which is not visible or easily accessible, etc.) is not operating (e.g., due to the circuit being off, etc.), which could result in potential elevated humidity levels in the basement. Further, using this data collected by the mobile sensor system 104 (e.g., the audio data associated with the fan, the visual data associated with the circuit breaker, etc.), it may be determined that the sump pump in the basement (e.g., which is not visible or easily accessible, etc.) is operating at higher than normal operating conditions (e.g., due to the dehumidifier not operating, etc.), which is resulting in excess energy and/or resource consumption. In this regard, and as will be explained in greater detail below, the mobile sensor system 104 may be configured to collect different types of residential data, which may be used to assess a condition or status of a component of the domicile, for example to allow a user or operator to implement one or more preventative and/or mitigative actions to improve a condition of the domicile (e.g., humidity level, energy consumption, etc.).

As shown, the residential system 102 may also be configured to communicate with the user device 110. The user device 110 may include one or more human-machine interfaces or client interfaces, shown as user interface 112 (e.g., a graphical user interface, a text-based computer interface, a client-facing web service, a web service that provides pages to a web client, etc.), for example for controlling, viewing, and/or otherwise interfacing with the residential system 102. The user device 110 may include a personal mobile computing device (e.g., a smart phone, a tablet, a mobile device, a wearable, smart glasses, a smart watch, etc.). The user device 110 may include a computer workstation, a client terminal, a remote or local interface, and/or any other user interface device. The user device 110 may be a stationary terminal (e.g., a desktop computer, a laptop computer, a tablet, or another suitable non-mobile device).

In various embodiments, information/data associated with the user device 110 may be communicated to the residential system 102. In certain implementations, the user device 110 itself may be configured to communicate information/data to the residential system 102. In certain embodiments, a device coupled to the user device 110, a component implemented with the user device 110, an application or program housed and/or executed on the user device 110, and/or another suitable component associated with the user device 110 may be configured to communicate information/data to the residential system 102.

In certain embodiments, the user device 110 may be configured to implement (e.g., execute, perform, realize, apply, etc.) one or more features and/or functionalities of one or more components of the residential services system 100 described elsewhere herein. In some embodiments, the user device 110 is, or includes the mobile sensor system 104. For example, the user device 110 may include one or more sensors and/or an application or program housed and/or executed on the user device 110, for example to execute the one or more features and/or functionalities of the mobile sensor system 104, as described herein. In certain embodiments, the user device 110 may be controlled (e.g., via the user device 110, the mobile sensor system 104, the residential system 102, etc.), for example to collect (e.g., gather, obtain, receive, retrieve, etc.) information (e.g., residential data, etc.) associated with one or more components, systems, and/or spaces associated with a domicile, as described herein.

For example, and as described elsewhere herein, the residential system 102 may be configured to receive data and/or information gathered and/or captured by the user device 110. For example, the user device 110 may include a microphone and/or a camera (e.g., for capturing audiovisual information, etc.). The user device 110 may capture (e.g., automatically, in response to an input, based upon a determined condition or state of at least a portion of the domicile, etc.) audiovisual data around the user device 110, for example while the user device 110 is moving about the domicile (e.g., in real-time, in near real-time, etc.). In some implementations, the user device 110 may capture audiovisual data around the user device 110 (e.g., a video, images, etc.), for example to communicate one or more types of residential data described herein (e.g., audio data associated with an operating status of a fan, visual data associated with an operating status of a sump pump, etc.) to the residential system 102. In certain embodiments, the user device 110 may also be configured to communicate audiovisual information (e.g., voice memos, voicemails, images, videos, etc.) stored on the user device 110 to the residential system 102.

The residential system 102 may also be configured to receive information/data associated with the user device 110. For example, the user device 110 may (e.g., automatically, or in response to an input, etc.) communicate geolocation and/or residential telematics data associated with the user device 110 (e.g., a location of the user device 110, a pattern of movement of the user device 110 about the domicile, and/or other similar geolocation and/or telematics data). As described herein, the user or operator may opt-in to sharing geolocation and/or telematics data with the residential system 102 (e.g., at predetermined times, in predetermined locations, during use of predetermined applications or services, during predetermined conditions of at least a portion of the domicile, etc.), and/or the user device 110 may communicate real-time and/or historic geolocation and/or telematics data associated with the user device 110.

In some implementations, the residential system 102 may be configured to receive information/data associated with a user or operator associated with the user device 110. For example, the user device 110 may (e.g., automatically, in response to an input r, etc.) be configured to communicate information associated with one or more applications (e.g., housed or executed on the user device 110) to the residential system 102. In certain implementations, the user device 110 may communicate residential and/or maintenance information associated with a user or operator (e.g., a domicile associated with the user or operator, etc.), for example from a bill pay or utilities application (e.g., associated with a utilities provider, etc.), a maintenance or residential care application, and/or similar applications. For example, the user device 110 may communicate information about an amount of water or energy consumption (e.g., via a bill pay or utilities application, etc.), a history or log of recent repairs and/or maintenance performed at the residence (e.g., recent repairs performed on a water softener of a plumbing system, recent routine maintenance to a septic system, etc., for example via a maintenance application, etc.), and/or other similar information or data.

The residential system 102 may also be configured to receive information associated with a product or service associated with a user or operator of the user device 110. For example, the user device 110 may (e.g., automatically, or in response to an input, etc.) communicate information associated with a domicile or residence associated with the user or operator (e.g., a home, etc.). In various embodiments, the user device 110 (e.g., via an application, a website, one or more interfaces, etc.) may be configured to prompt a user or operator (e.g., automatically, or in response to an input from the user or operator) for information associated with a product or service associated with the user or operator of the user device 110. For example, the user device 110 may prompt a user or operator (e.g., via a quiz, a questionnaire, a survey, a feedback form, etc.) for information associated with a domicile or residence of the user or operator, and the information may be communicated to the residential system 102.

In some embodiments, the information associated with the product or service (e.g., the residential building, residence, etc.) may include a geolocation of a domicile (e.g., an address, town, city, county, etc.), a size of the property, and/or a year the domicile was built. The information may include environmental-related information associated with the domicile (e.g., proximity to a body of water, seasonal hazards, average and/or amount of seasonal rainfall, etc.). The information may also include construction-related information, for example a builder, a material provider, a building timeline, materials used, a floorplan (e.g., square footage, number of floors, number of rooms, number of bathrooms, etc.), and/or any other suitable construction-related information (e.g., adherence to construction best practices, structural stability, architectural design, etc.).

In certain implementations, the information associated with the product or service (e.g., the residential building, residence, etc.) may include system and/or subsystem-related information associated with the domicile. For example, the information may include information associated with a plumbing system of the residence, such as whether the system is connected to public water or septic sources, whether the water source is a well or public utilities, etc. The information may also include information about components of the system and/or subsystem, for example characteristics associated with sinks, toilets, showers, dishwashers, washing machines, refrigerators, and/or other suitable appliances or devices (e.g., year, make, model, type, quality, smart-functioning capabilities, automated or sensor functionalities, etc.). Further, the information may include characteristics associated with the materials used in the systems and/or subsystems, and/or other suitable information or data.

In certain embodiments, the information associated with the product or service (e.g., the residential building, residence, etc.) includes information associated with maintenance, repair, and/or residential care associated with systems, subsystems, and/or components of the residence, as described herein. For example, the information may include a history of repairs and/or maintenance performed on a system of the residence, a history of claims and/or requests associated with a component or device of the system of the residence (e.g., a request to replace an overflowing septic system, etc.), and/or other suitable information or data.

In various embodiments, the information associated with the product or service (e.g., the residential building, residence, etc.) may also include information associated with a surrounding of the residence. For example, the information may include information on the presence of recreational products (e.g., a pool, hot tub, outdoor shower system, etc.), home care products (e.g., a sprinkler system, etc.), and/or other suitable information. Further, the information may include characteristics of a neighborhood or area surrounding the residence (e.g., year, make, model, builder/material provider, etc. of houses in the surrounding neighborhood, connections to public or private utilities or service providers, etc.), and/or any other suitable information.

In some embodiments, the residential system 102 may be configured to receive a request (e.g., associated with the user device 110). For example, the user device 110 (e.g., in response to an input from a user or operator, etc.) may communicate a request to the residential system 102. It should be understood that while the residential system 102 is described herein as receiving a request associated with the user device 110, it is contemplated that the residential system 102 may receive a request associated with any and/or all of the components of the residential services system 100 (e.g., the third-party system 130, the provider system 140, the computing system 150, etc.).

The request may identify a system, subsystem, and/or component a user or operator desires to know information about (e.g., a condition, a status, a well-being, an integrity, etc.). For example, the request may identify a system or component (e.g., a sump pump, a refrigerator, etc.), an attribute or characteristic, (e.g., operating efficiency, etc.), and/or an associated system or component (e.g., a plumbing system, etc.), which a user or operator desires to know information about (e.g., how the identified fluid characteristic of the sump pump affect the condition or status or another system or component of the domicile, etc.). The request may identify a plurality of systems (e.g., subsystems, components, etc.), attributes, and/or associated systems, for which the user or operator desires to know information about.

In certain implementations, the request may include additional information (e.g., an identified time period, a device identifier associated with the device that communicates the request, a feedback preference, etc.). For example, the request may include a feedback preference (e.g., a preference to receive feedback in the form of generating, modifying, updating, and/or altering a residential profile; a preference to receive feedback in the form of a maintenance recommendation; a preference to receive feedback in the form of a recommended action for improving a condition of the domicile, etc.).

As shown in FIG. 1, information/data associated with the residential devices 120 may also be communicated to the residential system 102. The residential devices 120 may be configured to communicate information/data to the residential system 102 (e.g., automatically, in response to a query, in response to an instruction, etc.). In some embodiments, a device coupled to, a system or device monitoring a residential device (e.g., the mobile sensor system 104, the user device 110, etc.), a device obtaining data from and/or regarding a device, and/or another suitable system or device associated with a residential device may be configured to communicate information/data to the residential system 102. In certain embodiments, the residential devices 120 may be associated with a domicile (e.g., a home, an apartment, a condominium, etc.) of a user or operator. The residential devices 120 may be associated with a residential system (e.g., a smart home system, etc.). For example, the residential devices 120 may be a set or group of devices that form a residential system (e.g., a smart home system, a smart residential plumbing system, etc.)

In various embodiments, the residential devices 120 may be associated with a system and/or a subsystem of a domicile. For example, the residential devices 120 may be associated with an HVAC system, a plumbing system, an electrical system, a lighting system, a security system, a fire detection and/or prevention system, and/or another suitable home and/or residential system and/or subsystem, etc. In certain embodiments, the residential device 120 may be associated with a space or area of a domicile. For example, the residential devices 120 may be associated with a kitchen, a family room, a dining room, a living room, a bedroom, a bathroom, a laundry room, an office, a playroom, a theater room, a basement, a garage, a gym, a closet, a pantry, an attic, a sunroom or seasonal room, a storage room, and/or any other suitable room or space of the domicile.

As an example, the residential device 120 may include an air conditioner, a dishwasher, a washing machine, a dryer, a freezer, a refrigerator, a stove, a water heater, a trash compactor, a microwave, and/or another suitable appliance. In some implementations, the residential device 120 may be associated with a system and/or subsystem of the domicile, for example a carbon monoxide detector/alarm, a smoke detector, a fire extinguisher, a fire escape ladder, etc. associated with a fire detection and/or prevention system. Further, the residential device 120 may include another device and/or component associated with a space or room. For example, the residential device 120 may include one or more devices or fixtures associated with a kitchen, for example a coffee maker, a deep fryer, a food processor, a blender, a toaster, an exhaust hood, a juicer, and/or another suitable device. As another illustrative example, the residential device 120 may include one or more devices or fixtures associated with a bathroom, for example a toilet, a bidet, a sink, a bathtub fixture, a showerhead, and/or another suitable fixture.

The residential device 120 may also be or include one or more components or devices coupled with a residential device, as described herein. For example, the residential device 120 may be or include a sensor (e.g., a pressure sensor, a temperature sensor, an occupancy sensor, a light sensor, etc.), a control valve (e.g., a pressure valve, a backflow valve, etc.), and/or other suitable components, for example to capture home telematics data. As described elsewhere herein, the residential system 102 may be configured to receive residential device information/data associated with the residential device 120 (e.g., automatically, in response to an input, etc.). For example, the residential system 102 may receive device related metrics associated with the residential device 120 (e.g., year, make, model, type, quality, smart-functioning capabilities, automated or sensor functionalities, etc.), operational characteristics associated with the operation of the residential device 120 (e.g., energy consumption, fluid or water drainage, etc.), and/or other residential related data described herein.

In certain implementations, the residential system 102 may be configured to receive historic device related information associated with the residential device 120. For example, the residential system 102 may receive information relating to historic operational characteristics and/or maintenance or repair information associated with the residential device 120. In various embodiments, the residential system 102 may receive notifications from the residential device 120 (e.g., an alert, alarm, warning notification, etc.), for example when operational characteristics of the residential device 120 exceeds/falls below a threshold, moves outside a predetermined range, etc.

As described herein, in some embodiments the device related information/data may be used to assess and/or analyze a condition and/or a status of a system, subsystem, and/or a component thereof. For example, the device related information/data of a first device (e.g., an operating status of a fan in the basement) may be used (e.g., in part) to assess a condition or a status of another device of a domicile (e.g., an operating efficiency of a sump pump in the basement). Further, the determined condition or status (e.g., an operating efficiency of the sump pump) may be used in generating a recommendation for improving a condition of the domicile (e.g., a recommendation to flush to sump pump to improve the operating efficiency of the sump pump), as described herein.

As shown, the residential system 102 may be configured to receive information/data associated with the third-party system 130. The third-party system 130 may include a third-party application 132. While the residential services system 100 is shown to include one third-party system 130, it is contemplated herein that the residential services system 100 may include a plurality of third-party systems 130. In certain embodiments, the residential system 102 may be configured to receive residential information/data associated with the third-party system 130. For example, the residential system 102 may be configured to receive residential data, as described herein, from and/or associated with the third-party system 130.

In some embodiments, the third-party system 130 may be associated with a public entity. For example, the third-party system 130 may be associated with a city, a town, a village, a municipality, and/or another suitable government entity. The residential system 102 may be configured to receive (e.g., automatically, and/or in response to an input, etc.) map and/or land information (e.g., addresses, lot diagrams, water systems, water lines, septic systems, septic lines, well location, electric power lines, telephone lines, and/or other suitable map and/or land plot information).

In some embodiments, the third-party system 130 may be associated with a public utility entity. For example, the third-party system 130 may be associated with a water or electrical utility entity. The residential system 102 may be configured to receive residential information associated with the third-party system 130 (e.g., reports, studies, test results, etc., including, for example, resource quality information, resource characteristic data, resource supply information, resource treatment information, etc.). In certain implementations, the third-party system 130 may be associated with a private utility entity. For example, the third-party system 130 may be associated with a private water or electrical utility entity, and the residential system 102 may be configured to receive information associated with the third-party system 130. In some implementations, the residential system 102 may be configured to receive historic residential data.

As shown, information/data associated with the provider system 140 may be communicated to the residential system 102. In certain embodiments, the provider system 140 may be configured to communicate information/data to the residential system 102. In some embodiments, a device coupled to, a component implemented with the provider system 140, an application or program housed and/or executed on the provider system 140, and/or another suitable component associated with the provider system 140 may be configured to communicate information/data to the residential system 102.

The provider system 140 may include a provider application 142. In various embodiments, the provider system 140 may be associated with a company or entity that provides protective services (e.g., insurance, etc.) to a user or operator (e.g., a user or operator associated with the user device 110), a company or service provider (e.g., a provider associated with the third-party system 130), and/or over one or more products or services (e.g., associated with the residential device 120, etc.). The provider system 140 may include one or more components of the residential services system 100 (e.g., the residential system 102, the mobile sensor system 104, etc.), as described herein. The provider system 140 may be configured to communicate with the residential system 102 (and/or the user device 110), for example to initiate an action related to a domicile and/or to provide one or more policy parameters, as described herein.

In some embodiments, the residential system 102 may be configured to receive a policy parameter. The provider system 140 may be configured to provide a policy parameter (e.g., to the residential system 102, to the user device 110, to other components of the residential services system 100, etc.). A policy parameter may refer to a parameter of one or more insurance products (e.g., coverages, policy terms, premiums, etc.). In certain embodiments, the policy parameter may be selected, generated, and/or offered, for example to provide coverage, supplement and/or increase existing coverage, and/or to provide new coverage. In certain implementations, the provider system 140 may be configured to generate a plurality of policy parameters. For example, the provider system 140 may be configured to generate a plurality of policy parameters associated with a condition or status of one or more components of a domicile, a modification to one or more components of the domicile, and/or a recommendation associated with the condition or status of the one or more components of the domicile, as will be described herein.

In various embodiments, the policy parameters may be selected, generated, and/or offered based upon a policy availability and/or a policy source, a policy availability location, and/or additional parameters (e.g., a cost, a time over which the policy is available, a product or service over which the policy is available, a location over which the policy is available, ability to group or bundle different policies or parameters, available discounts or rewards associated with a policy or parameter, etc.).

As noted herein, in certain embodiments the residential system 102 may be configured to receive one or more policy parameters associated with a condition or a status of a device or a system of a domicile. For example, a policy may be generated (e.g., via the provider system 140) that provides coverage over a domicile and/or the systems, subsystems, and/or components therein. In various embodiments, as a benefit or reward for having domicile with a device or a system that satisfies a predetermined condition and/or status (e.g., a sump pump operating above a threshold efficiency, a sump pump that has been flushed within the past year, etc.), at least one policy parameter may be generated that provides a benefit to a user (e.g., an insurance policy, a discount, a reward, a cost-savings, a cost reduction to an existing policy, an increase in coverage, an increase in duration of coverage of a policy, etc.). Similarly, as a benefit or reward for improving a condition or a status (e.g., an improvement in an operating condition of the sump pump via a maintenance action, a modification, etc.), at least one policy parameter may be generated that provides a benefit to a user.

In addition, and as noted herein, in some implementations the residential system 102 may be configured to receive one or more policy parameters associated with a recommendation (e.g., a recommendation for improving a condition of a domicile, etc.). For example, as a benefit or reward for implementing a maintenance action and/or modification, at least one policy parameter may be generated that provides a benefit to a user.

In some embodiments, the one or more policy parameters may also be generated using one or more factors associated with a domicile, a system, a subsystem, and/or a component thereof For example, one or more policy parameters may be generated using a base policy (e.g., cost, rate, coverage, etc.), a location rating factor (e.g., neighborhood, city, state, urban location, rural location, etc.), a coverage rating (e.g., availability, amount, term, etc. of coverage), a claim rating factor (e.g., based upon historical claim information associated with the domicile, similarly situated buildings in the neighborhood or city, similarly situated buildings built by the same builder or contractor, similarly situated buildings connected to the same utility provider, etc.), a maintenance and/or residential care discount (e.g., a routine maintenance discount, a timely repair discount, etc.), a resource efficiency discount (e.g., a use of resource and/or energy efficient components and/or devices associated with the residential building, etc.), a safety impact discount, and/or a combination thereof. The one or more policy parameters may be selected and/or generated, for example to provide a benefit or reward to a user associated with the domicile, systems, subsystems, and/or components thereof.

In some embodiments, the policy parameter may be associated with various forms of coverage of an individual, for example comprehensive coverage, liability coverage, rental coverage, medical payments coverage, emergency assistance coverage, personal injury coverage, incidental injury coverage, and/or other suitable residential related coverages.

As shown, the residential system 102 may be configured to communicate with the computing system 150. The computing system 150 may be a cloud-based computing system, for example to provide digital connections between different computing devices and/or systems (e.g., as described herein). The computing system 150 may be a virtual reality (VR) system or augmented reality (AR) system, for example to provide digital connections between a plurality of metadata sources, where the metadata sources are integrated within the VR system or AR system.

In various embodiments, the computing system 150 may be implemented using one or more computing devices, for example operating alone and/or in combination. In various embodiments, the computing system 150 may be implemented using computing architectures like multiple distributed servers, and/or similar computing devices and/or systems. In certain embodiments, the computing system 150 may be a server (e.g., including a processor coupled to a memory), for example to store and/or recall data and applications within the memory. In some embodiments, the computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the residential system 102 may be configured to communicate with the storage system 160 (e.g., having the database 162). The residential system 102 may communicate with the storage system 160, either directly (e.g., via the network 170) or indirectly (e.g., via the user device 110, the residential devices 120, etc.). The storage system 160 may include one or more devices (e.g., RAM, ROM, Flash memory, hard disk storage, etc.) for storing data and/or computer code for implementing and/or facilitating the various processes, layers, and/or circuits described herein. The storage system 160 may be or include volatile memory or non-volatile memory, and may include database components, object code components, script components, and/or any other type of information structure for supporting the various activities and information structures described herein.

In certain embodiments, and as will be discussed in greater detail, the residential system 102 may also be configured to generate data. For example, the residential system 102 may include components (e.g., a compiler, an analyzer, an action generator, and a database) that obtain, analyze, process, generate, store, and/or communicate data.

For example, the residential system 102 may be configured to initiate one or more actions relating to a domicile. For example, the residential system 102 may (i) receive a plurality of different types of residential data (e.g., residential data associated with a component or a space of a domicile, etc.), where the residential data may be received via a mobile sensor as the sensor moves about at least a portion of the domicile; (ii) determine, by processing the different types of residential data using a trained machine learning model, at least one of a condition or a status of a device or a system of the domicile, where the trained machine learning model is trained using historical data to establish a correlation between (a) a subset of the plurality of different types of residential data and (b) a condition or status associated with the device or the system of the domicile; (iii) generate, using the at least one condition or status of the device or the system of the domicile, a recommendation for improving a condition of the domicile; and/or (iv) provide the recommendation to a user, for example a recommended preventative and/or mitigative action.

### Exemplary Residential Building Assessment System

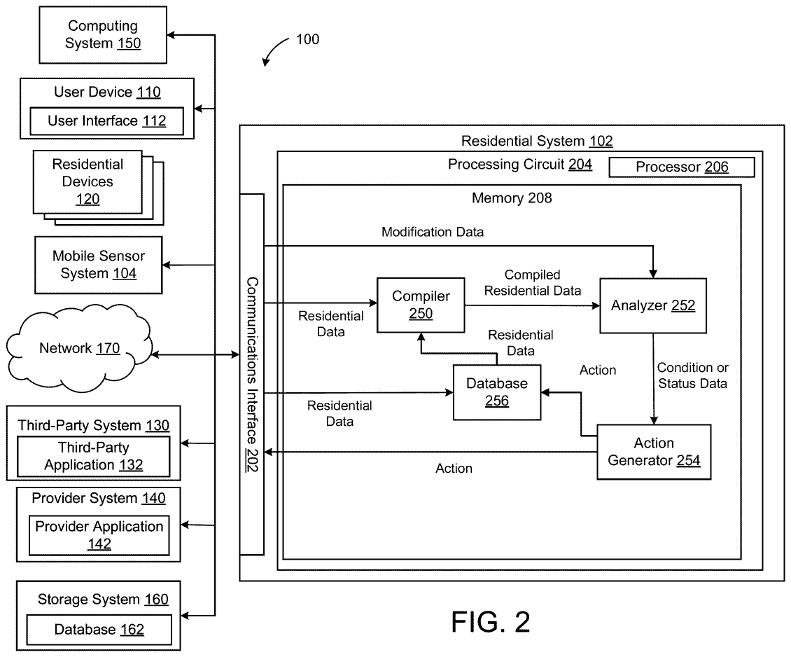

Referring now to FIG. 2, a block diagram of the example residential building assessment system, e.g., the residential system 102, is shown in greater detail, according to some embodiments. As discussed above, the residential system 102 may be configured to initiate one or more actions relating to a domicile (e.g., a system, subsystem, component, etc. associated with the domicile). For example, the residential system 102 may be configured to (i) determine and/or provide at least one of a condition or a status of a device or a system of the domicile, and/or (ii) initiate an action (e.g., generate a recommendation, etc.) for improving a condition of the domicile (e.g., an operating condition of a system of the domicile, a characteristic of space of the domicile, etc.).

In various embodiments, the residential system 102 may be configured to receive different types of residential data associated with at least one component or space of the domicile (e.g., a fan, a dehumidifier, a fire alarm, etc.; a basement, a kitchen, a living room, etc.). The residential system 102 may receive the different types of residential data, for example from a mobile sensor as the sensor moves about at least a portion of the domicile (e.g., one or more sensors of the mobile sensor system 104, a portable robot, a movable robot, moveable rover and drone combination, a camera or phone couple with a movable device, for example a vacuum, a drone, etc.). In some implementations, the residential data includes audio data associated with an audio characteristic of the component or the space (e.g., audio data associated with an operating condition of the fan, etc.). The residential system 102 may further be configured to determine, by processing the plurality of different types of residential data (e.g., using a trained machine learning model, etc.), at least one of a condition of a status of a device or a system of the domicile (e.g., an operating condition of the fan and/or the dehumidifier, a humidity or moisture level in the basement, etc.).

In some embodiments, in response to determining a condition or a status of the device or the system of the domicile, the residential system 102 may be configured to initiate an action relating to the domicile. For example, in some instances the residential system may generate a recommendation for improving a condition of the domicile, which may be provided to a user (e.g., on a display of a mobile device or other computing device, or otherwise present the residential impact score to a user, such as visually or audibly via one or more computing devices, AR glasses, VR headsets, voice bots, chatbots, etc.), for example for review and/or analysis. In certain embodiments, the recommendation for improving the condition of the domicile may include, for example a recommended maintenance action, a recommended preventative action, a recommended mitigative action, and/or another suitable recommendation.

As shown in FIG. 2, the residential system 102 may be communicably connected to the mobile sensor system 104, the user device 110, the residential devices 120, the third-party system 130, the provider system 140, the computing system 150, and the storage system 160 (e.g., via the network 170). The residential system 102 may be communicably connected to other suitable systems and/or devices (e.g., via the network 170), including those devices mentioned elsewhere herein. It should be understood that some or all of the components of the residential system 102, the mobile sensor system 104, the user device 110, the residential devices 120, the third-party system 130, the provider system 140, the computing system 150, the storage system 160, and/or the network 170 may be implemented as art of a cloud-based computing system configured to obtain, process, and/or communicate data from one or more external devices or sources.

Similarly, some, or all, of the components of the residential system 102, the mobile sensor system 104, the user device 110, the residential devices 120, the third-party system 130, the provider system 140, the computing system 150, the storage system 160, and/or the network 170 may be integrated within a single device or be distributed across multiple separate systems or devices. In certain implementations, residential system 102, the mobile sensor system 104, the user device 110, the residential devices 120, the third-party system 130, the provider system 140, the computing system 150, the storage system 160, and/or the network 170 are components of a controller, a device controller, a field controller, a computer work station, a client device, and/or another system or device that receives, processes, and/or communicates data from/to devices or other data sources.

As shown, the residential system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the residential system 102, and external systems or devices (e.g., the mobile sensor system 104, the user device 110, the residential devices 120, the third-party system 130, the provider system 140, the computing system 150, the storage system 160, etc.). In various embodiments, the communications interface 202 facilitates communications between the residential system 102 and one or more external applications and/or interfaces (e.g., the user interface 112, the third-party application 132, the provider application 142 etc.), for example to allow a remote user or operator to control, monitor, and/or adjust components of the residential system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the residential system 102 may obtain, ingest, and process data from any type of system or device, regardless of the communications protocol used by the system or device.

As shown, the residential system 102 may include the processing circuit 204 having the processor 206 and the memory 208. While shown as single components, it should be appreciated that the residential system 102 may include one or more processing circuits, including one or more processors and memories or other computer-readable storage media.

In some implementations, the residential system 102 may include a plurality of processors, memories, interfaces, and/or other components distributed across multiple devices or systems, which are communicably coupled via a network (e.g., the network 170). For example, in a cloud-based or distributed implementation, the residential system 102 may include multiple discrete computing devices, each of which include a processor 206, memory 208, communications interface 202, and/or other components of the residential system 102. Tasks performed by the residential system 102 may be distributed across multiple systems or devices, which may be located within a single building or facility or distributed across multiple buildings or facilities. In other embodiments, the residential system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. The memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the residential system 102 (e.g., the memory 208) may include a residential data compiler, shown as compiler 250, a residential data analyzer, shown as analyzer 252, an action initiator or action generator, shown as action generator 254, and a database 256. The following paragraphs describe some of the general functions performed by each of the components 250-256 of the residential system 102. It should be noted that the number and type of components shown is merely illustrative and, in certain embodiments, implementations of the residential system 102 may have additional, fewer, and/or different components than those illustrated in FIG. 2.

In some embodiments, the compiler 250 may be configured to obtain input data, analyze the input data, and/or generate output data to be communicated to other components of the residential system 102. For example, the compiler 250 may obtain (e.g., receive, request, pull, etc.) residential data. As described herein, the residential data may be received from an external system or device (e.g., an edge device, the mobile sensor system 104, the user device 110, the residential devices 120, the third-party system 130, the provider system 140, the computing system 150, and/or the storage system 160, etc.), for example via the communications interface 202. The residential data may be received in real-time, or near real-time, and/or at predetermined intervals. For example, in certain instances the residential data may be received in sequence (e.g., at a first time, at a second time following the first time, etc.), for example based upon an instruction and/or command provided to one or more external systems or devices (e.g., an instruction provided to the mobile sensor system 104, for example from the residential system 102, etc.). In certain implementations, the residential data includes historic residential data.

In some implementations, the compiler 250 may obtain (e.g., receive, request, pull, etc.) residential data that includes information and/or data associated with a sensor device or sensor system (e.g., the mobile sensor system 104, etc.). As described herein, the mobile sensor system 104 may include one or more sensos (e.g., mobile sensors, movable sensors, portable sensors, etc.), which may be configured to collect (e.g., gather, determine, obtain, etc.) one or more types of residential data, for example while the mobile sensor system 104 (e.g., the one or more sensors, etc.) moves about at least a portion of a domicile. The mobile sensor system 104 may include a portable robot, a movable robot, a camera or sensor (e.g., phone, etc.) coupled with a movable device (e.g., a vacuum, etc.), a drone, and/or any other suitable sensor and/or device described herein. The mobile sensor system 104 may collect and/or communicate the residential data (e.g., to the residential system 102, the compiler 250, etc.) continuously, at predetermined times (e.g., in accordance with a schedule, etc.), at predetermined conditions (e.g., in response to an input from a user, in response to an occupancy characteristic of a space of the domicile, in response to an instruction or command, etc.), and/or any suitable time and/or condition.

In some implementations, the residential data may be associated with one or more systems, subsystems, devices, and/or spaces associated with a domicile, as described herein (e.g., a plumbing system, a sump pump, a fan, etc.; a basement, a kitchen, a living room, etc.). The residential data may include audiovisual data (e.g., images, pictures, videos, voice records, audio records, and/or any other suitable type of audio or visual data or information), for example associated with a device and/or space of a domicile. The residential data may include non-audio data, for example temperature data, light data, motion data, gas data, occupancy data, and/or any other suitable data collected by the one or more sensors of the mobile sensor system 104, as described herein.

In certain implementations, the residential data includes additional and/or different data described herein. For example, the residential data may include geolocation information (e.g., information associated with a location where the data is obtained, etc.), for example indicating that different types of residential data may have been obtained from different spaces and/or locations in the domicile (e.g., different rooms, different floors, etc.). The residential data may include temporal information (e.g., associated with a time the data is obtained, etc.), for example indicating that different types of residential data may have been obtained at the same and/or different times (e.g., simultaneously or substantially simultaneously, within a 30-minute window, on different days, etc.). The residential data may also include information associated with a system and/or device that obtains the data (e.g., different systems or device of the mobile sensor system 104, etc.), for example indicating that different types of residential data may have been obtained from the same and/or different devices of the mobile sensor system 104.

In some implementations, and as described elsewhere herein, the residential data may be obtained at predetermined times, under predetermined conditions, and/or in accordance with one or more controls or instructions. In this regard, the residential data may include information indicating that the residential data was obtained while the mobile sensor system 104 was implementing one or more actions, for example according to a schedule. In some implementations, the mobile sensor system 104 may be configured to obtain residential data in accordance with one or more controls or instructions (e.g., an input or approval from a user or operator, an instruction or command communicated from the residential system 102, etc.). In this regard, the residential data may also include information indicating that the residential data was obtained in accordance with a command or instruction (e.g., in accordance with an instruction provided by the residential system 102, etc.).

In certain embodiments, the residential data may include information or data associated with a user (e.g., the user device 110). For example, the residential data may include user data (e.g., obtained from the user device 110, automatically, or in response to an input, etc.). As described herein, the user data may include geolocation data, residential telematics data, and/or data gathered and/or captured by and/or around the user device 110 (e.g., audiovisual data, for example videos, images, voice memos, voicemails, etc.), such as with the user's permission or authorized consent.

The residential data (e.g., the user data, etc.) may also include information or data associated with a user or operator associated with the user device 110. For example, the user data may include information associated with one or more applications (e.g., housed or executed on the user device 110), including residential and/or maintenance information (e.g., via a bill pay or utilities application, a maintenance or residential care application, and/or similar applications, etc.).

The residential data (e.g., the user data, etc.) may also include information or data associated with a product or service associated with a user or operator of the user device 110. For example, the user data may include information associated with a domicile associated with the user or operator (e.g., a home, apartment, building, etc. information, including geolocation information, a size of the property, a year the residence was built, environmental-related information, etc.), as described herein.

In some implementations, the residential data may include information or data associated with a residential device (e.g., the residential device 120). For example, the residential data may include device data (e.g., obtained from the residential device 120, automatically, or in response to an input, etc.). As described herein, the device data may include device related metrics associated with the residential device 120 (e.g., year, make, model, type, quality, smart-functioning capabilities, automated or sensor functionalities, etc.). The device data may also include operational characteristics associated with the operation of the residential device 120 (e.g., operating efficiency, operational status, energy consumption, fluid or water drainage, etc.).

In various embodiments, the residential data (e.g., the device data) also includes device identification and/or configuration data. For example, the device data may include a device identifier (e.g., an identifier indicating a type of device of the residential device 120, for example an air conditioner, a dishwasher, a washing machine, a dryer, a freezer, a refrigerator, a stove, a water heater, etc.). In various embodiments, the device data may include information or data associated with a component and/or configuration of the residential device 120 (e.g., information or data associated with a pressure sensor, a temperature sensor, an alarm, etc.), again gathered or collected with user permission or authorized consent. The device data may include material characteristics and/or properties associated with the residential device 120. In various embodiments, the device data includes additional data and/or information associated with the residential device 120 described herein.

In some embodiments, the residential data may include information or data associated with a third-party system (e.g., the third-party system 130). For example, the residential data may include third-party data (e.g., obtained from the third-party system 130, automatically, or in response to an input, etc.). The third-party data may include data associated with a public entity (e.g., a city, a town, a village, a municipality, etc.), for example map and/or land plot information (e.g., lot diagrams, water systems, septic lines, etc.).

In some embodiments, the third-party data is associated with one or more third-party entities (e.g., gas, electricity, telephone, waste disposal, communications systems, etc. entities), as described herein. For example, the residential data (e.g., the third-party data) may include data associated with a public utility entity (e.g., reports, studies, test results, etc.), as described herein. In various embodiments, the residential data (e.g., third-party data) may also include data associated with a private utility entity (e.g., reports, studies, test results, etc.), as also described elsewhere herein. In certain implementations, the third-party data includes historic third-party data, and/or any other suitable data associated with the third-party system 130, as described herein.

In various embodiments, the residential data may include information or data associated with a provider system (e.g., the provider system 140). For example, the residential data may include provider data (e.g., obtained from the provider system 140, automatically, or in response to an input, etc.). As described herein, the provider system 140 may be associated with a company that provides protective services (e.g., insurance, etc.) to a user or operator, a company, service provider, and/or one or more products or services.

In certain embodiments, the provider data may include one or more policy parameters associated with one or more users, operators, services or service providers, products, and/or services. The provider data (e.g., one or more policy parameters, etc.) may be provided using historical policy parameter information (e.g., historic policy characteristics, etc.), and/or one or more additional policy parameters (e.g., cost, discounts, availability, policy source, a policy availability location, a time over which the policy is available, a product or service over which the policy is available, eligibility requirements, ability to group or bundle different policies or parameters, available discounts or rewards associated with a policy or parameter, etc.), as described herein.

In some implementations, residential data may include information or data associated with a computing system (e.g., the computing system 150) and/or a storage system (e.g., the storage system 160). The residential data may include historic and/or real-time residential related information (e.g., system, subsystem, and/or component information), for example from (e.g., directly, or indirectly) the computing system 150 and/or the storage system 160, as described herein. The residential data may be received by the residential system 102 in real-time and/or at one or more series or intervals (e.g., hourly, daily, etc., automatically in response to a request and/or an event associated with the mobile sensor system 104, the user device 110, the residential device 120, the third-party system 130, the provider system 140, etc.).

In certain implementations, the compiler 250 may be configured to obtain (e.g., receive, request, pull, etc.) a request (e.g., a condition or status request, etc.). The request may be received from an external system or device (e.g., an edge device, the user device 110, etc.), for example via the communications interface 202. As described herein, the request may identify a domicile, a system, a subsystem, and/or a component, for example for which a user or operator desires to know information about (e.g., a condition, a status, a well-being, an integrity, etc.). For example, the request may identify a component (e.g., a sump pump, etc.) and/or an attribute (e.g., an operating condition, for example operating efficiency, an operating status, etc.) that a user or operator desires to know information about (e.g., how the attribute of the identified component affects a condition of the domicile, etc.).

In some embodiments, the request may identify a plurality of systems (e.g., subsystems, components, etc.) and/or attributes (e.g., characteristics, criteria, and/or qualities), for which a user or operator desires to know information about. In certain embodiments, the request may also include additional information (e.g., a time or time-period associated with the request, etc.) and/or a preference (e.g., a feedback preference of a user to receive feedback in the form of a recommended action for improving a condition of the domicile, etc.).

As shown, and as described herein, the compiler 250 may be configured to obtain input data (e.g., residential data, a plurality of different types of residential data, etc.), analyze the input data, and/or generate output data. For example, the compiler 250 may be configured to obtain (e.g., receive, request, pull, etc.) residential data, analyze (e.g., compile, process, etc.) the data, and/or generate compiled residential data. The compiled residential data may be communicated to another component of the residential system 102 (e.g., the analyzer 252). In certain embodiments, the compiled residential data may include data associated with a plurality of different types of residential data, and/or one or more instructions to identify (e.g., generate, determine, etc.) a condition or status associated with a device or a system of the domicile, as will be discussed below.

In some embodiments, the analyzer 252 may be configured to obtain input data, analyze the input data, and/or generate output data to be communicated to other components of the residential system 102. For example, the analyzer 252 may obtain (e.g., receive, request, pull, etc.) compiled residential data, analyze the data, and/or generate condition or status data associated with the compiled residential data.

As shown, the analyzer 252 may be configured to analyze the compiled residential data and generate condition or status data, such as with user permission and authorized consent. As described herein, the compiled residential data may include a plurality of different types of residential data (e.g., audio data, visual data, temperature data, light or motion data, etc.), for example associated with at least one component or space of a domicile (e.g., a fan, a sump pump, a dehumidifier, etc.; a basement, a kitchen, a living room, etc.). As also described herein, the compiled residential data may include a plurality of different types of residential data and additional information (e.g., geolocation information, temporal information, device information, etc.). Further, the compiled residential data may include one or more instructions to identify (e.g., generate, determine, etc.) a condition or a status of a device and/or a system of the domicile (e.g., associated with the compiled residential data, etc.). As will be described herein, the condition or status data may indicate a condition (e.g., an operating efficiency, a temperature level, etc.) and/or a status (e.g., an idle operating status, an off operating status, etc.) of a device and/or a system of the domicile, as described herein.

In certain implementations, the analyzer 252 may be or include one or more trained machine learning models and/or predictive models. For example, the analyzer 252 may be and/or include (e.g., implement, execute, perform, etc.) one or more machine learning models trained using historical residential data (e.g., historical residential data, historical requests, historical instructions to determine a condition or a status of a system, subsystem, and/or a component of a domicile, etc.). The machine learning models may be configured to establish one or more correlations between (i) a plurality of different types of residential data (and/or one or more subsets thereof) and (ii) a condition or a status associated with a device or a system of the domicile.

For example, and as will be described in greater detail herein, the one or more trained machine learning models may be configured to obtain a plurality of different types of residential data (e.g., data collected via the mobile sensor system, user data, residential device data, third-party data, provider data, etc.), and analyze the residential data to determine a condition and/or a status of a system, subsystem, and/or device of a domicile. In some implementations, the one or more trained machine learning models may be configured to estimate an impact of the condition and/or the status, for example on a condition (e.g., health, well-being, integrity, operating efficiency, etc.) of the domicile (and/or a system, subsystem, and/or component thereof).

In certain embodiments, the analyzer 252 may be configured to train the one or more machine learning models and/or predictive models (e.g., using historical residential data, etc.). In various embodiments, the analyzer 252 may be configured to retrain one or more machine learning models (e.g., one or more trained machine learning models, etc.), for example via input and/or feedback data (e.g., subsequent residential data, user or operator input, etc.). It should be understood that while the trained machine learning model is described herein as a single machine learning model, it is contemplated that the trained machine learning model may be and/or include one or more machine learning models (e.g., trained machine learning models, etc.). Further, the trained machine learning model may be configured to implement one or more features and/or functions described herein. For example, the trained machine learning model may implement, execute, and/or perform one or more features and/or functions performed by the analyzer 252, the action generator 254, and/or any other suitable component described herein.

In various embodiments, the trained machine learning model may include one or more regression trees, deep neural networks, supervised learning model, unsupervised learning models, nearest neighbor, generative adversarial (GANs), stable diffusers, generative artificial intelligence (GAI), transformers, or many other types of models. The trained machine learning model may utilize generative artificial intelligence (AI) models (also referred to as generative machine learning (ML) models) and/or other AI/ML models, which may employ supervised, unsupervised, and/or semi-supervised machine learning techniques, which may be used in conjunction with, reinforced and/or reinforcement learning techniques. In some implementations, the trained machine learning model may be configured to implement machine learning, such that trained machine learning model (e.g., the analyzer 252) “learns” to analyze, organize, and/or process data without being explicitly programmed.

In various embodiments, the trained machine learning model may utilize and/or implement a voice bot, chatbot, ChatGPT bot, ChatGPT-based bot, and/or other such generative model (referred to broadly as “chatbot” herein), which may be used for implementing, training, utilizing, and/or otherwise providing an AI or ML model to a user for dialogue interaction (e.g., “chatting”). The chatbot may utilize and/or be trained according to language models, such as natural language processing (NLP) models, large language models (LLMs), and/or generative adversarial network (GAN) techniques. For example, an LLM or other type of model may receive data from one or more mobile sensors and translate the data into a description of the potential issues and/or status observed in the spaces, potential actions to be taken in response, etc.

In various embodiments, the trained machine learning model may be used in conjunction with a machine vision, image recognition, object identification, AR glasses, VR headsets, other input/output devices, and/or other image processing techniques, as described herein. In various embodiments, the trained machine learning model may be used with any and/or all of the machine learning, generative artificial intelligence, and/or other advanced computing techniques described herein.

In some embodiments, the trained machine learning model (e.g., the analyzer 252) may be configured to determine (e.g., estimate, predict, etc.) a condition of a system, subsystem, and/or device of a domicile. For example, the trained machine learning model (e.g., the analyzer 252) may receive compiled residential data (e.g., including different types of residential data, for example collected via the mobile sensor system 104, the user device 110, etc.), analyze the data, and determine a condition (e.g., an operating efficiency, an energy consumption, etc.) associated with the system, subsystem, and/or device.

In certain embodiments, the trained machine learning model (e.g., analyzer 252) may be configured to determine (e.g., estimate, predict, etc.) a status of a system, subsystem, and/or device of a domicile. For example, the trained machine learning model (e.g., the analyzer 252) may receive compiled residential data, analyze the data, and determine a status (e.g., an operating status, an inactive alarm or warning status, etc.) of the system, subsystem, and/or device.

In certain implementations, the trained machine learning model (e.g., the analyzer 252) may further be configured to determine (e.g., estimate, predict, etc.) a condition or a status of a space (or a portion thereof) of a domicile. For example, the trained machine learning model (e.g., the analyzer 252) may receive compiled residential data, analyze the data, and determine a condition (e.g., a humidity level, a temperature, etc.) and/or a status (e.g., an occupancy status, a temperature, etc.) associated with a space of a domicile. In this regard, the trained machine learning model (e.g., the analyzer 252, etc.) may be configured to obtain compiled residential data, analyze the data, and/or estimate a condition and/or a status associated with a system, subsystem, device, and/or space of a domicile.

As an illustrative example, the trained machine learning model (e.g., the analyzer 252, etc.) may be configured to receive compiled residential data, for example including different types of residential data, as described herein. For example, the compiled residential data may include audio data (e.g., an audio clip or recording, etc.) and visual data (e.g., an image or video, etc.), for example obtained via one or more mobile sensor (e.g., a portable robot, a drone, etc.). The audio data may be associated with an audio characteristic of a first device (e.g., audio data indicating a fan is operating or running) and/or the visual data may be associated with a second device (e.g., a visual indication that a circuit breaker has been tripped or is off, etc.).

The trained machine learning model (e.g., the analyzer 252) may be configured to analyze the compiled residential data, and determine a condition or a status of a device or a system. For example, the trained machine learning model may analyze the audio and visual data (e.g., associated with the first and second devices, etc.), and determine a status of another device (e.g., determine that the dehumidifier is not operating or is off, for example as a result of the circuit being off and/or due to the activation of the fan, etc.). Similarly, the trained machine learning model may analyze the audio and visual data, and determine a condition of another device (e.g., determine that the sump pump is operating at higher-than-normal operating conditions, for example due to the dehumidifier not operating or being of, etc.). Advantageously, and as will be described herein, the trained machine learning model may be used to assess a plurality of different types of residential data (e.g., which are otherwise difficult to obtain and/or not often associated, etc.), for example to determine a status and/or condition of a system, subsystem, device, and/or space of a domicile, which may be used to assess conditions and/or implement one or more actions (e.g., preventative, mitigative, etc.) to improve a condition of the domicile.

As another illustrative example, the trained machine learning model (e.g., the analyzer 252, etc.) may be configured to receive compiled residential data (with user permission and/or authorized consent), for example including different types of residential data (e.g., including geolocation information, etc.), as described herein. For example, the compiled residential data may include first audio data (e.g., an audio clip or recording of a kitchen, etc.), for example obtained from a first mobile sensor device or system (e.g., a portable robot, a camera or sensor coupled with a movable device, for example a vacuum, etc.). The compiled residential data may also include second audio data (e.g., an audio clip or recording of a garage, etc.) and/or visual data (e.g., an image or video), for example obtained from a second mobile sensor device or system (e.g., a drone, etc.). The data may include geolocation data, for example associated with a location (e.g., a location where the data is obtained). For example, the first audio data may be associated with an audio characteristic of a first device at a first location (e.g., audio data indicating a fluid or liquid is flowing in the kitchen, etc.), the second audio data may be associated with an audio characteristic of a second device at a second location (e.g., audio data indicating a fan is running in the garage, etc.), and/or the visual data may be associated with a characteristic of a third location (e.g., a visual indication that a circuit breaker has been tripped or is off, etc.).

In some implementations, the trained machine learning model (e.g., the analyzer 252) may be configured to analyze the compiled residential data (and/or a subset thereof, etc.), and determine a condition or a status of a device or a system. For example, using the geolocation information, the trained machine learning model (e.g., the analyzer 252) may be configured (e.g., trained, etc.) to determine there is not a correlation between the second audio data (e.g., audio data indicating a fan is running in the garage, etc.), and the first audio data (e.g., audio data indicating a fluid or liquid is flowing in the kitchen, etc.) and/or the visual data (e.g., a visual indication that a circuit breaker has been tripped or is off, etc.). In this regard, the trained machine learning model (e.g., the analyzer 252) may be configured to identify subsets of correlated (e.g., related, etc.) and/or non-correlated (e.g., unrelated, etc.) data within the compiled residential data.

The trained machine learning model (e.g., the analyzer 252) may further be configured to analyze the correlated data (e.g., the first audio data and the visual data), for example to determine a status of another device (e.g., determine a sump pump is not operating, for example as a result of too much power being drawn by a circuit in the house and/or resulting in water flowing into the dishwasher in the kitchen, etc.). Advantageously, the trained machine learning model may be used to assess a plurality of different types of residential data (e.g., which are otherwise difficult to obtain and/or not often associated, etc.), for example to determine a status and/or condition of a system, subsystem, device, and/or space of a domicile, which may be used to assess conditions and/or implement one or more actions (e.g., preventative, mitigative, etc.) to improve a condition of the domicile.

As yet another illustrative example, the trained machine learning model (e.g., the analyzer 252, etc.) may be configured to receive compiled residential data, for example including different types of residential data (e.g., including temporal or time information, etc.), as described herein. For instance, the compiled residential data may include audio data (e.g., an audio clip or recording of a kitchen, etc.), for example obtained from a first mobile sensor device or system (e.g., a portable robot, a camera or sensor coupled with a movable device, for example a vacuum, etc.). The compiled residential data may also include first visual data (e.g., an image or video of a basement, etc.), for example obtained from a second mobile sensor device or system (e.g., a drone, etc.). The compiled residential data may further include second visual data (e.g., an image or video of the basement, etc.), for example obtained in response to an instruction or command (e.g., an instruction or command provided by the residential system 102, for example instructing the mobile sensor system 104 to obtain additional residential data, etc.).

As described herein, the data may include temporal or time data, for example associated with a time (e.g., a time when the data is obtained). For example, the audio data may be associated with an audio characteristic of a first device at a first location (e.g., audio data indicating a fluid or liquid is flowing in the kitchen, etc.), the first visual data may be associated with a characteristic of a second device and/or space at a first time (e.g., a video of a basement at a first time, etc.), and the second visual data may be associated with a characteristic of another device and/or space at a second time (e.g., an image of the basement at a second time, etc.).

In some implementations, the trained machine learning model (e.g., the analyzer 252) may be configured to analyze the compiled residential data (and/or a subset thereof, etc.), and determine a condition or a status of a device or a system. For example, using the time information, the trained machine learning model (e.g., the analyzer 252) may be configured (e.g., trained, etc.) to determine there is not a correlation between the first visual data (e.g., a video of the basement obtained at 11:45 PM yesterday, etc.), and the audio data (e.g., audio data indicating a fluid or liquid is flowing in the kitchen, etc.) and/or the second visual data (e.g., an image indicating that a circuit breaker has been tripped or is off from 10:30 AM today, etc.).

In this regard, the trained machine learning model (e.g., the analyzer 252) may be configured to identify subsets of correlated (e.g., related) and/or non-correlated (e.g., unrelated) data within the compiled residential data. The trained machine learning model (e.g., the analyzer 252) may further be configured to analyze the correlated data (e.g., the audio data and the second visual data, which are correlated in time, etc.), for example to determine a status of another device (e.g., determine a sump pump is not operating, for example as a result of too much power being drawn by a circuit in the house and/or resulting in water flowing into the dishwasher in the kitchen, etc.). Advantageously, the trained machine learning model may be used to assess a plurality of different types of residential data (e.g., which are otherwise difficult to obtain and/or not often associated, etc.), for example to determine a status and/or condition of a system, subsystem, device, and/or space of a domicile, which may be used to assess conditions and/or implement one or more actions (e.g., preventative, mitigative, etc.) to improve a condition of the domicile.

In some implementations, and as described elsewhere herein, the compiled residential data may include user data, third-party data, provider data, and/or other suitable data described herein. The trained machine learning model may use the user data, third-party data, provider data, and/or other suitable data (or a combination thereof) to determine a condition or a status of a system, subsystem, device, and/or space of a domicile.

As described herein, “condition” of a system, subsystem, device, and/or space may generally refer to a state, an environment, and/or a situation associated with the system, subsystem, device, and/or space. For example, and as a non-limiting example, a “condition” may refer to a characteristic of a device (e.g., a presence of a vent, a leak, a crack, buildup, deterioration, stain, etc.). A “condition” may include an operating condition of a device (e.g., a level of efficiency of energy, electrical, water, financial, and/or other resource consumption, etc.). A “condition” or a potential “condition” may refer to a potential safety and/or health risk associated with a potential failure and/or potential damage associated with a device (e.g., presence of an obstruction, moisture, exposed material or components, etc.).

As also described herein, “status” of a system, subsystem, device, and/or space may generally refer to a category or a circumstance associated with the system, subsystem, device, and/or space. For example, and as a non-limiting example, a “status” of a device may refer to an operating status (e.g., on, active, operating, etc.), a non-operating status (e.g., off, inactive, non-operational, etc.), an idle status, and/or another suitable status. In certain implementations, a “status” of a space may refer to a circumstance (e.g., an occupancy condition, a motion condition, etc.) and/or characteristic associated with the space (e.g., a humidity level, a temperature level, a gas level etc.).

As described herein, a condition and/or a status associated with a system, subsystem, device, and/or space may be determined (e.g., estimated, predicted, calculated, etc.), for example, using one or more rules, algorithms, and/or models (e.g., the trained machine learning model, etc.). For example, the trained machine learning model (e.g., the analyzer 252) may be configured to determine a condition and/or a status associated with a system, subsystem, device, and/or space using one or more rules and/or rule-based logic. The rules and/or rule-logic may be used along with historical residential related data, and/or may be iteratively updated and/or trained using subsequent residential related data.

As shown, and as described herein, the analyzer 252 (e.g., the trained machine learning model, etc.) may be configured to obtain input data (e.g., compiled residential data, etc.), analyze the data, and/or generate output data. For example, the trained machine learning model may be configured to obtain (e.g., receive, request, pull, etc.) compiled residential data, analyze (e.g., compile, process, etc.) the data, and generate condition or status data. The condition or status data may indicate a condition or a status associated with a system, subsystem, device, and/or space associated with a domicile, as described herein. The condition or status data may be communicated to another component of the residential system 102 (e.g., the action generator 254).

In some embodiments, the action generator 254 may be configured to obtain input data, analyze the input data, and/or generate output data to be communicated to other components of the residential system 102. For example, the action generator 254 may obtain (e.g., receive, request, pull, etc.) condition or status data, analyze the data, and/or initiate an action associated with the condition or status data, for example to improve a condition of the domicile.

In certain implementations, the action generator 254 is and/or includes one or more trained machine learning models and/or predictive models. For example, the action generator 254 may be and/or include (e.g., implement, execute, perform, etc.) the one or more trained machine learning models described herein with reference to the analyzer 252. The trained machine learning model may be configured to implement one or more features and/or functions described herein. For example, the trained machine learning model may implement, execute, and/or perform one or more features and/or functions performed by the analyzer 252, the action generator 254, and/or any other suitable component described herein.

In various embodiments, the action generator 254 may initiate an action that includes a score (e.g., a residential impact score, a health score, a wellness score, etc.). For example, the action generator 254 may initiate an action that includes a user interface that provides an impact score (e.g., to a user or operator, etc.), or otherwise audibly or visually presents the residential impact score, such as via a computing device, display screen, or voice bot. In certain implementations, the impact score indicates an impact of the condition and/or status of the system, subsystem, device, and/or space, for example on an estimated remaining useful life or remaining life of the domicile (and/or an associated system, subsystem, component, and/or space). The impact score may indicate an impact of the condition and/or status of the system, subsystem, device, and/or space on a health metric associated with the domicile (e.g., a health or safety measure associated with operating under the condition or status, a potential health or safety impact on an occupant of the domicile associated with operating under the condition or status, etc.).

In some implementations, the action generator 254 is configured to initiate an action that includes one or more indicators. For example, the action generator 254 may initiate an action that includes an indicator indicating a potential impact (e.g., low, medium, high, etc.) on a system, subsystem, device, and/or space associated with the condition and/or the status. In certain instances, the one or more indicators may indicate a potential level of impact (e.g., low, medium, high, etc.) on a user or operator (e.g., health or safety risk, et.) associated with the condition and/or the status.

In various embodiments, the action generator 254 may initiate an action that includes a recommendation. For example, the action generator 254 may initiate an action that includes a recommendation for improving a condition of the domicile (e.g., an operating efficiency, resource consumption, potential safety and/or health risks, etc.). The recommendation may include, for example, at least one of a recommended preventative action and/or a mitigative action, including, for example, a maintenance action (e.g., a recommendation to flush a sump pump, etc.), a component to add to a system or subsystem (e.g., a filtration system, etc.), a component to remove from a system or subsystem (e.g., a pressure valve, shut off valve, etc.), a component to replace in a system or subsystem (e.g., a filter, etc.), and/or other similar recommendation.

In some implementations, the action generator 254 may initiate an action that includes additional information. For example, the action generator 254 may initiate an action that includes a recommendation (e.g., for improving a condition of the domicile, etc.), along with additional information associated with the recommendation. The action generator 254 may be configured to generate a recommendation including a proposed maintenance and/or service provider, a proposed maintenance or service window, a proposed cost and/or review information associated with the maintenance and/or service provider, and/or additional information associated with the recommendation.

In certain embodiments, the residential system 102 (e.g., the action generator 254, etc.) may be configured to analyze residential data in generating the recommendation and/or the associated information. For example, the action generator 254 may be configured to analyze user data (with user permission) including, for example, a schedule or calendar associated with a user, third-party data including information relating to service and/or maintenance providers (e.g., location, reviews, cost, services offered, availability, etc.), and/or other associated information (e.g., a budget associated with a user, a service or repair timeline, etc.).

In certain implementations, the residential system 102 (e.g., the action generator 254, etc.) may be configured to analyze the user data and/or the third-party data, for example to generate a recommendation that includes a proposed maintenance or service provider (e.g., via third-party or user reviews, etc.), a proposed maintenance or service window where the user and/or the third-party is available to complete the maintenance and/or service, a proposed cost or timeline associated with the proposed maintenance or service, and/or other associated information. The action generator 254 may be configured to generate an action instruction (e.g., including a recommendation, additional information associated with the recommendation, etc.) that includes a user interface that provides the recommendation and/or additional information (e.g., a proposed maintenance provider, a proposed time or window for service, a proposed cost, etc.), for example for review by the user or operator (e.g., for the user to approve, reject, propose a modification or alternative service, time, cost, etc.).

In some embodiments, the recommendation may be generated via a machine learning model (e.g., a trained machine learning model, etc.), for example trained using different potential actions that could be taken (e.g., preventative and/or mitigative actions, including, for example, maintenance actions, repair actions, etc.) relating to different combinations of input conditions (e.g., geographic location, materials, system configurations, system and/or device conditions, system and/or device statuses, etc.). In various embodiments, the recommendation may be generated via a generative model, as described herein, for example to predict an impact of different actions that could be taken and/or to identify an action that most positively impacts a domicile (e.g., a condition associated with the domicile, a status associated with the domicile, etc.). In various embodiments, the recommendation may be generated using any and/or all of the various machine learning and/or artificial intelligence models and/or methods described herein.

In certain embodiments, the action generator 254 may initiate an action that includes information relating to one or more policy parameters. As described herein, the action generator 254 may initiate an action that includes a policy parameter associated with a condition and/or a status of a system, subsystem, device, and/or space associated with a domicile, and/or an associated recommendation. For example, as a benefit or reward for having a predetermined condition and/or status (e.g., above a predetermined threshold, within a predetermined range, etc.), at least one policy parameter may be provided as a benefit to a user (e.g., an insurance policy, a discount, a cost-savings, a cost reduction to an existing policy, an increase in coverage, an increase in duration of coverage of a policy, etc.). Further, as a benefit or reward to implementing a preventative and/or mitigative action (e.g., a maintenance action, a modification, etc.) at least one policy parameter may be provided as a benefit to a user.

In various embodiments, the action generator 254 may further be configured to communicate the action (e.g., recommendation, etc.) to one or more devices, systems, and/or environments. For example, the action generator 254 may be configured to communicate the action (e.g., recommendation, etc.) to the user device 110 (e.g., via the communications interface 202), for example for display (e.g., via the user interface 112) or voice reproduction, such as in the case of a voice bot, ChatGPT bot, etc.

Additionally or alternatively, the action generator 254 may be configured to communicate the action (e.g., recommendation, etc.) to the database 260 and/or the storage system 160 (e.g., via the communications interface 202 via the network 170), for example for storage and/or subsequent action (e.g., recommendation, etc.) generation. The action generator 254 may be configured to communicate the action (e.g., recommendation, etc.) to the third-party system 130, the provider system 140, and/or the computing system 150 (e.g., via the communications interface 202 via the network 170), for example for storage and/or subsequent analysis (e.g., authorization, verification, etc.).

In some embodiments, the database 256 is configured to obtain (e.g., receive, request, pull, etc.), store, and/or output (e.g., provide, send, etc.) data and/or information. For example, the database 256 may be configured to receive residential data (e.g., data collected via a mobile sensor system, user data, residential device data, third-party data, provider data, etc.), as described herein In certain implementations, the database 256 may be configured to provide data (e.g., residential data, etc.) to other components of the residential system 102 (e.g., the compiler 250, etc.). For example the database 256 may be configured to obtain residential data (e.g., associated with a user, associated with a domicile, associated with a town or municipality, associated with utility entity, etc.), store the residential data, and/or provide the residential data to the compiler 250, for example for use in subsequent assessments of conditions and/or statuses of one or more components of a domicile (e.g., a system, subsystem, device, and/or space, etc.).

In various embodiments, the systems, methods, and/or functionalities described herein may be performed in a sequence (e.g., over a period of time, etc.), as part of an iterative process, repeated, and/or be otherwise performed. For example, the compiler 250 may be configured to receive residential data (e.g., from the mobile sensor system 104, etc.) for example associated with a first time and/or location (e.g., audiovisual data associated with a kitchen at 10 AM, which is obtained in accordance with a schedule, etc.), and a second time and/or location (e.g., audiovisual data associated with a basement at 10:15 AM, which is obtained in accordance with an instruction or command, etc.). As described herein, the compiler 250 may be configured to receive residential data, which may be obtained automatically (e.g., in accordance with a schedule or automated instruction, etc.) and/or in accordance with one or more commands and/or instructions (e.g., in response to an instruction provided via the residential system 102, in response to an approval or instruction provided via an occupant or owner of the domicile, etc.).

Further, and as described herein, the action generator 254 may initiate an action, which may include a condition and/or a status associated with a system, subsystem, device, and/or space of a domicile, an associated recommendation (e.g., a recommendation for improving a condition of the domicile, etc.), and/or additional information associated with the recommendation (e.g., a proposed maintenance or service provider, a proposed maintenance or service window where the user and/or the third-party is available to complete the maintenance and/or service, a proposed cost or timeline associated with the proposed maintenance or service, etc.). In certain embodiments, the action includes one or more policy parameters (e.g., associated with the recommendation, etc.), as described herein. The action (e.g., the recommendation, etc.) may be provided to a user or operator (e.g., via a user interface, or otherwise audibly or visually, etc.).

In some embodiments, the user may assess the recommendation, and/or implement one or more actions. For example, a user or operator may implement one or more preventative and/or mitigative actions, including a maintenance action (e.g., clean or flush a component or system, etc.), a modification action (e.g., repair, replace, and/or remove a component, etc.), and/or an action to cease performing certain actions (e.g., cease leaving water running, etc.). The residential system 102 may be configured to receive information and/or data associated with the one or more implemented actions (e.g., a preventive and/or mitigative action, a maintenance action, a modification action etc.). For example, the residential system 102 may receive residential modification data or modification data (e.g., automatically, or in response to an input, etc.).

In some implementations, the residential system 102 may receive residential modification data or modification data, for example from the mobile sensor system 104. For example, and as described elsewhere herein, the mobile sensor system 104 may include one or more sensors configured to collect different types of residential data, for example as the mobile sensor system 104 moves about at least a portion of a domicile. In certain implementations, following an action instruction (e.g., a recommendation, etc.), the mobile sensor system 104 may collect residential data, for example audio data, visual data, temperature data, etc. associated with a component and/or a space of a domicile, as described herein. The mobile sensor system 104 may communicate the residential data (e.g., as modification data, residential modification data, etc.) to the residential system 102, which may be used to verify and/or confirm a recommendation, as described herein.

In certain implementations, the residential system 102 may receive residential modification data or modification data, for example from the user device 110 (e.g., via the user interface 112), the residential device 120, the third-party system 130, and/or the provider system 140, for example via the communications interface 202 (e.g., via the network 170). Further, the analyzer 252 may obtain (e.g., receive, request, pull, etc.) modification data and/or analyze the modification data. The analyzer 252 may be configured to obtain the modification data, and compare the modification data with one or more sets of condition and/or status data (e.g., a recommendation associated with a condition or a status, etc.), for example via communication with the database 256. The analyzer 252 may compare the modification data with the one or more sets of condition and/or status data, for example to verify that an action associated with the modification data (e.g., a preventative action, a mitigative action, a maintenance action, a modification action, etc.) matches a recommendation for improving a condition of the domicile.

In some implementations, the analyzer 252 may obtain (e.g., receive, request, pull, etc.) modification data at predetermined intervals. For example, the analyzer 252 may be configured to obtain modification data in real-time (e.g., via the mobile sensor system 104, the user device 110, etc.), for example based upon a predetermined time period (e.g., an operating schedule of the mobile sensor system 104, etc.), a predetermined condition (e.g., an occupancy characteristic of at least a portion of the domicile, etc.), and/or an instruction or input (e.g., an instruction provided via the residential system 102, an input from a user or operator for the mobile sensor system 104 to collect data associated with at least a portion of the domicile, etc.). In certain implementations, the analyzer 252 may be configured to obtain modification data at predetermined time intervals (e.g., every hour, 2 hours, 6 hours, 12 hours, 24 hours, bi-weekly, weekly, etc.).

In some embodiments, the residential system 102 may be configured to monitor one or more components of the residential services system 100 (e.g., the mobile sensor system 104, the user device 110, the residential device 120, etc.), for example to determine whether a modification (e.g., service, maintenance, repair, etc. action) matches a recommendation, as described herein. For example, the residential system 102 (e.g., the mobile sensor system 104, the analyzer 252, etc.) may monitor the residential device 120 (e.g., a sump pump, etc.), for example to determine whether a modification matches a recommendation (e.g., determine whether the water heater was flushed in accordance with the recommendation, etc.). The residential system 102 may monitor and/or determine additional information associated with a modification (e.g., a time associated with a repair action, a person and/or provider that performs the action, a type of material or component used in the maintenance or repair action, etc.), for example to provide a benefit and/or reward for implementing a recommended preventative and/or mitigative action, as described herein. The residential system 102 may receive data from other systems, such as a system associated with a service provider, to validate whether a recommended improvement has been implemented.

In various embodiments, the analyzer 252 is also configured to generate additional data. For example, the trained machine learning model (e.g., the analyzer 252) may be configured to generate updated condition or status data, for example associated with the modification data, as described herein. In certain implementations, the updated condition or status data indicates an improvement in a condition of the domicile. The updated condition or status data may be communicated to another component of the residential system 102. For example, and as described herein, the updated condition or status data may be communicated to the action generator 254, and/or the action generator 254 may be configured to initiate an action. The action may include a user interface that provides, among other features, a score associated with the modification, information relating to one or more policy parameters, and/or any other suitable information described herein.

In this regard, the systems, methods, and/or functionalities described herein may be implemented as part of an iterative process, for example to provide users and/or operators with information associated with available actions (e.g., preventative actions, mitigative actions, etc.), which may afford users additional benefits and/or advantages. For example, the systems and methods described herein use a trained machine learning model and different types of residential data (e.g., data which is otherwise inaccessible, data which is difficult to obtain, and/or data which is not traditionally correlated and/or associated, etc.) to determine a condition or a status of a device, which may be utilized by users, for example, to implement one or more preventative and/or mitigative actions. For example, a user may implement a preventative and/or mitigative action (e.g., a maintenance and/or modification action, a repair action, etc.) to reduce and/or prevent potential damage to components of a domicile (e.g., a sump pump, components of an associated system or subsystem, for example a refrigerator or dishwasher, etc.), thereby reducing resource consumption associated with the potential damage (e.g., water, electrical, and/or energy consumption associated with operating a damaged component, financial resources associated with repairing and/or replacing damaged components, etc.).

Further, the determined condition or status may be utilized, for example, to implement a preventative and/or mitigative action (e.g., a maintenance and/or modification action, a repair action, etc.) to reduce and/or prevent potential inefficient operating conditions of a component of the domicile, thereby also reducing resource consumption associated with the inefficient operating conditions (e.g., water, electrical, and/or energy consumption, etc.). In addition, the determined condition or status may advantageously be utilized, for example, to implement a preventative and/or mitigative action (e.g., a maintenance and/or modification action, etc.) to reduce potential health and/or safety risks associated with a potential failure and/or potential damage to the domicile (e.g., health and/or safety risks associated with a potential flooding and/or leaking event, health and/or safety risks associated with a potentially undetectable flooding and/or leaking event, for example potential exposure to bacteria or mold, or rotting or erosive conditions in the residential building, etc.). In some implementations, as a benefit or reward for implementing a preventative and/or mitigative action (e.g., a recommended maintenance action, a recommended modification, etc.) and/or for maintaining and/or having certain residential conditions and/or statuses, at least one policy parameter may be provided as a benefit to a user.

### Exemplary Residential System & Functionality

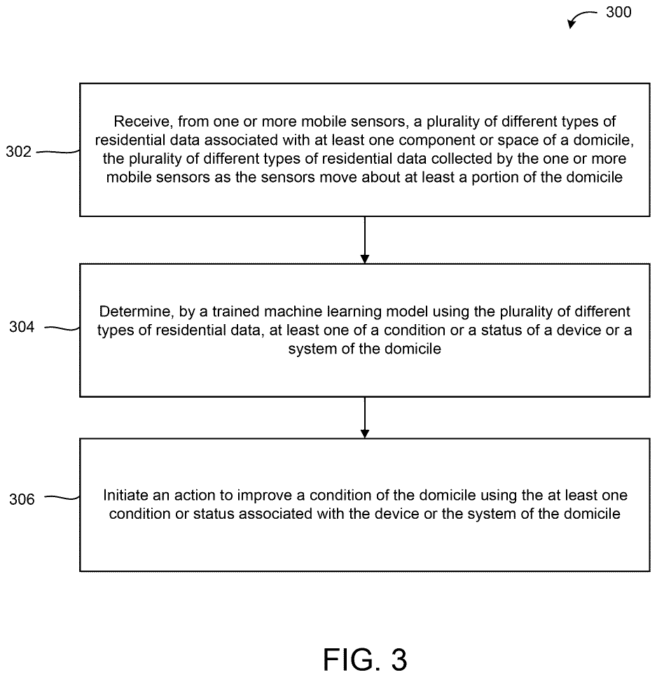

Referring now to FIG. 3, a computer-implemented or computer-based process, shown as process 300, for assessing a condition or a status of a system (or component thereof) of a domicile is shown, according to various embodiments. Computer-implemented process 300 may be implemented by any and/or all the components of the residential services system 100 of FIGS. 1-2 (e.g., the residential system 102, etc.). It should be appreciated that any and/or all the process 300 may be implemented by other systems, devices, and/or components (e.g., components of the residential services system 100, the residential system 102, etc.). Further, it should be appreciated that in some embodiments, process 300 may implemented using additional, different, and/or fewer operations, actions, and/or functionality.

Computer-implemented process 300 may include receiving residential data (block 302), according to some embodiments. The residential data may include a plurality of different types of residential data. For example, the residential data may be associated with a system, subsystem, device, and/or space of a domicile (e.g., a fan, a sump pump, a dehumidifier, etc.; a basement, a kitchen, a living room, etc.). Further, the residential data may include audio data and/or non-audio data, including, for example, visual data, temperature data, light data, motion data, occupancy data, and/or any other suitable data (or combination thereof) described herein.

In some embodiments, the residential data includes a first type of data and a second type of data that is different than the first type of data. For example, the residential data may include audio data associated with an audio characteristic of a fan operating in a basement, and/or visual data (e.g., an image) associated with an image of a circuit breaker box in the basement. Further, the residential data may humidity data associated with an area or space in a basement, and visual data (e.g., a video) associated with a sump pump in a crawl space of the domicile.

In some implementations, the residential data may be received from an external or remote device. For example, the residential data may be received from the mobile sensor system 104 (e.g., a portable or moveable robot, a drone, a camera or sensor coupled with a movable device, for example a vacuum, etc.). In some implementations, the residential data may be received from one or more mobile sensors (e.g., of the mobile sensor system 104, etc.). For example, a first set of residential data may be collected via a first mobile sensor (e.g., a first movable robot, a portable robot, a camera or phone mounted to a movable device, for example a vacuum, etc.) and/or a second set of residential data may be collected via a second mobile sensor (e.g., a drone, etc.). As described herein, the mobile sensor system 104 may collect and/or communicate residential data in real-time, or near real-time.

The mobile sensor system 104 may collect and/or communicate the residential data, for example as the mobile sensor system 104 (e.g., the one or more mobile sensors, etc.) moves about at least a portion of a domicile (e.g., within a kitchen, between floors, between levels, for example a kitchen or living room and a basement, etc.). For example, the mobile sensor system 104 may collect and/or communicate audiovisual data as the mobile sensor system 104 moves between a first portion of the domicile (e.g., a kitchen, a living room, etc.) and a second portion of the domicile (e.g., a basement, etc.). The mobile sensor system 104 may collect and/or communicate residential data as the mobile sensor system 104 is stationary (e.g., in a single location, in a single position, etc.). As described herein, the mobile sensor system 104 may collect and/or communicate residential data utilizing one or more mobile sensors (e.g., a first movable or portable robot, a second drone, etc.), where the residential data may include additional information (e.g., geolocation information, temporal or time information, device information, for example associated with when/where/how the residential data is obtained, etc.).

In certain implementations, the mobile sensor system 104 may be configured to collect and/or communicate residential data at predetermined times, under predetermined conditions, and/or in predetermined locations. For example, the mobile sensor system 104 may collect and/or communicate residential data in accordance with a schedule (e.g., when a user or owner of the domicile is at work, or outside the domicile). In some implementations, the mobile sensor system 104 may be configured to collect and/or communicate residential data associated with a predetermined space (e.g., a living room, a basement, etc.), but not another space (e.g., a bedroom, a bathroom, etc.).

In various implementations, the mobile sensor system 104 may be configured to collect and/or communicate residential data in response to an input. For example, based upon a first set of residential data (e.g., audio data associated with a kitchen, etc.), the mobile sensor system 104 may receive an instruction (e.g., command, control, etc., for example from the residential system 102, etc.) to collect and/or communicate additional residential data (e.g., visual data associated with a basement and/or a device or system therein, etc.). Further, in some instances, in response to receiving an input from a user (e.g., an instruction, an approval, etc.), the mobile sensor system 104 may collect and/or communicate residential data associated with a predetermined location (e.g., a bedroom, a bathroom, etc.).

In this regard, in some implementations the mobile sensor system 104 may be controllable so as to implement one or more subsets of the operations and/or functionalities described herein. For example, the mobile sensor system 104 may move about a portion of a domicile (e.g., a bedroom, a bathroom, etc.), collecting and/or communicating a first set of residential data (e.g., temperature data, etc.) without collecting and/or communicating a second set of residential data (e.g., visual data, audio data, etc.). In some implementations, the mobile sensor system 104 may move about a portion of a domicile (e.g., a living room, etc.) collecting and/or communicating a first set of residential data (e.g., motion data, etc.) without collecting and/or communicating a second set of residential data (e.g., visual data, audio data, etc.).

In certain implementations, the mobile sensor system 104 may determine a characteristic (e.g., using the collected data, etc.) of a portion of the domicile, for example an occupancy characteristic (e.g., determine that the living room is not occupied, etc.). Based upon the characteristic (e.g., the occupancy characteristic, a determination that the living room is unoccupied, etc.), the mobile sensor system 104 may move about the portion of the domicile (e.g., the living room, etc.), for example collecting and/or communicating a set of residential data (e.g., visual data, audio data, etc.), which may not have been previously collected.

It should be understood that the scenarios described herein (e.g., of the one or more subsets of the operations and/or functionalities that may be implemented by the mobile sensor system 104) are provided for exemplary and/or illustrative purposes and are not intended to limit the operations and/or functionalities described herein. For example, the mobile sensor system 104 may further be configured to move about at least a portion of a domicile via a schedule and/or in accordance with a map. The mobile sensor system 104 may be implemented with augmented and/or predictive movement technology, for example to move to a device and/or space (e.g., a sump pump in a crawl space of a basement, a fire alarm in a bedroom, etc.) in response to collecting and/or communicating a certain set of residential data (e.g., visual data illustrating a leaking facet, temperature data indicating an elevated temperature in a basement, etc.).

Computer-implemented process 300 may include determining at least one of a condition or a status of a device or a system of the domicile (block 304), according to some embodiments. In some implementations, process 300 may include determining at least one of a condition or a status of a system, subsystem, device, and/or a space of a domicile. The condition or the status may be determined using the plurality of different types of residential data and/or additional information (e.g., residential data received via a mobile sensor as the sensor moves about at least a portion of the domicile, geolocation and/or time information associated with the residential data, etc.). As described herein, the condition may relate to a characteristic of a system or a device (e.g., an operating efficiency, a resource consumption, etc.; presence of a crack or leak, etc.), a potential characteristic of a system or device (e.g., a potential failure or potential damage associated with the system or device, etc.), and/or other suitable information described herein. A status may refer to an operating status (e.g., operating, non-operating, on, off, idle, etc.), a circumstance (e.g., an occupancy characteristic of a space, a humidity or temperature level of a space, etc.), and/or other suitable information described herein.

In some embodiments, the condition or the status (e.g., of the system, subsystem, device, and/or space) may be determined using a trained machine learning model, and/or one or more trained machine learning models (e.g., by processing the plurality of different types of residential data, etc.). As described herein, the trained machine learning model is trained (e.g., using historical residential data, etc.) to establish at least one correlation between residential data and a condition or a status associated with a system, subsystem, device, and/or space of a domicile. For example, the trained machine learning model may be trained to establish at least one correlation between (i) a plurality of different types of residential data, and (ii) a condition or a status associated with a device, a system, and/or a space of the domicile.

In some implementations, the trained machine learning model is trained to establish at least one correlation between (i) a first type of residential data and a second type of residential data, and (ii) a condition or a status associated with a device, a system, and/or a space of the domicile (e.g., where the first type and the second type are the same, where the first type and the second type are different, etc.). As described herein, the trained machine learning model is used with any and/or all of the machine learning, generative artificial intelligence, and/or other advanced computing techniques described herein.

Computer-implemented process 300 may include initiating an action for improving a condition of the domicile (block 306), according to some embodiments. For example, in response to determining a condition or a status of a device or a system of the domicile, an action may be initiated for improving a condition of the domicile (e.g., based upon the determined condition or the status of associated with the device or system, etc.). In some implementations, the action is generated using the at least one condition or status.

As described herein, the action may include providing a user interface that provides a score (e.g., to a user or operator, etc.), or otherwise audibly and/or visually presents the score, such as via a computing device, display screen, or voice bot. The score may be associated with a residential impact score, a health score, a wellness score, an integrity score, for example indicating an impact (e.g., a remaining useful life, a health, a wellness, an integrity, etc.) on the domicile (and/or associated systems or components thereof) of the determined condition and/or status. The action may include providing one or more indicators, for example indicating a potential impact (e.g., high, medium, low) associated with the determined condition and/or status. As described elsewhere herein, the potential impact may be associated with one or more associated systems, subsystems, devices, and/or spaces, and/or an occupant or individual associated with the domicile (e.g., potential health or safety risks, etc.).

In some embodiments, the action is or includes a recommendation. The recommendation may be associated with improving a condition of the domicile. For example, the action (e.g., recommendation) may include a recommended preventative action and/or a mitigative action, including, for example, a maintenance action, a repair action, a replacement action, and/or an action to cease performing. As described herein, the recommendation may also include additional information associated with the recommendation (e.g., a proposed maintenance or service provider, a proposed maintenance or service window where the user and/or the third-party is available to complete the maintenance and/or service, a proposed cost or timeline associated with the proposed maintenance or service, etc.).

In some implementations, the computer-implemented process 300 may include providing the action to the user. For example, in response to initiating an action for improving a condition of the domicile, the action may be provided to the user. In some implementations, providing the action to the user includes generating a user interface that provides a recommendation for improving a condition of the domicile to the user, or otherwise audibly and/or visually presents the recommendation, such as via a computing device, display screen, or voice bot.

In some embodiments, computer-implemented process 300 may include providing one or more policy parameters. For example, the action (e.g., recommendation, etc.) may include information relating to one or more policy parameters (e.g., relating to the determined condition or status and/or the associated recommendation, etc.). For instance, as a benefit or reward for having a device or system that has a predetermined condition and/or status (e.g., above a threshold, within a predetermined range, etc.), at least one policy parameter may be provided as a benefit to a user (e.g., an insurance policy, a discount, a reward, a cost reduction to an existing policy, an increase in coverage, an increase in duration of coverage of a policy, etc.). Further, as a potential benefit or reward to implementing a recommended preventative and/or mitigative action (e.g., a maintenance action, a modification, a repair action, etc.), at least one policy parameter may be provided as a potential benefit to a user.

In certain embodiments, computer-implemented process 300 may include receiving modification data, maintenance data, and/or repair data. For example, a user may assess the determined condition and/or status of a system, device, and/or space of their residence (and/or the associated recommendation), and, for example, implement one or more actions. As described herein, the user may implement one or more preventative and/or mitigative actions, including a maintenance action, a modification, and/or an action to cease performing certain actions. Subsequent to the one or more implemented actions, information and/or data associated with the one or more actions may be received (e.g., via the mobile sensor system 104, the user device 110, the residential device 120, the third-party system 130, the provider system 140, etc.), as described herein. In certain implementations, one or more components of the residential services system 100 (e.g., the residential device 120, etc.) is/are monitored (e.g., via the mobile sensor system 104, etc.), for example to obtain information and/or data associated with one or more actions (e.g., an implemented preventative or mitigative action, etc.).

In certain implementations, the modification data may be received and/or compared with one or more sets of data (e.g., condition and/or status data, an associated recommendation, etc.), for example to verify that an action associated with the modification data (e.g., a maintenance action, a modification action, etc.) matches a recommendation for improving a condition of a domicile. In various embodiments, using the modification data, a modified condition and/or status of a system, subsystem, device, and/or space associated with the domicile may be determined. The modified condition and/or status information may, for example, indicate an improvement in a condition of the domicile (e.g., an operating efficiency, an energy or resource consumption, etc.).

In certain implementations, a policy parameter associated with the modified condition and/or status (and/or an associated recommendation) may be provided. For example, and as described herein, as a benefit or reward for having the modified condition and/or status of a system or a space of the domicile meet a predetermined threshold (e.g., above a predetermined threshold, within a predetermined range, etc.), at least one policy parameter may be provided as a benefit to a user. Further, as a benefit or reward to implementing a preventative and/or mitigative action (e.g., a recommended maintenance action, a recommended modification, etc.), at least one policy parameter may be provided as a benefit to a user.

Advantageously, the systems and methods described herein leverage the advantages provided by a trained machine learning model, using different types of residential data (e.g., obtained via one or more mobile sensors, including data which is otherwise inaccessible, data which is difficult to obtain, and/or data which is not traditionally correlated and/or associated, etc.), in order to determine a condition or a status of a system or space of a domicile, which may be utilized by users, for example, to implement one or more beneficial preventative and/or mitigative actions (e.g., to prevent potential damage to components of a domicile, to prevent inefficient operating conditions, to reduce potential health and/or safety risks associated with a potential event, etc.).

### Exemplary User Interface Displaying Recommendation

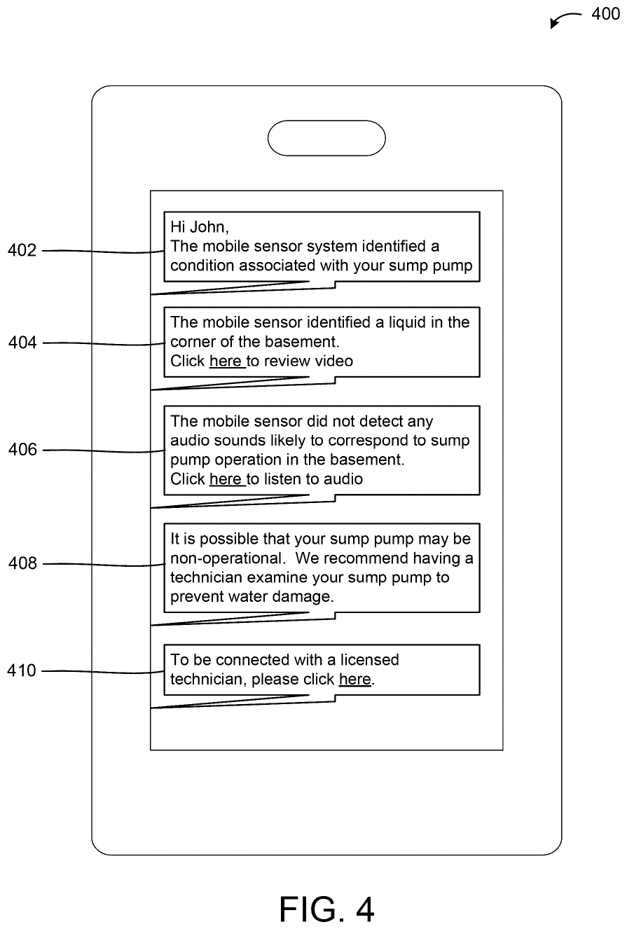

Referring to FIG. 4, a computer-generated user interface, shown as user interface 400, is shown, according to some embodiments. The computer-generated user interface 400 may be generated by any and/or all the components of the residential services system 100 of FIGS. 1-2 (e.g., the residential system 102, etc.). It should be appreciated that any and/or all the user interface 400 may be implemented by other systems, devices, and/or components (e.g., components of the residential services system 100, the residential system 102, etc.). It should be appreciated that in certain embodiments, user interface 400 may be implemented using additional, different, and/or fewer operations, actions, and/or functionality.

As shown in FIG. 4, the computer-generated user interface 400 may include one or more communications and/or indicators. The communications may be associated with (e.g., generated by, implemented by, etc.) any and/or all of the components of the residential services system 100 of FIGS. 1-2 (e.g., the residential system 102, etc.). For example, the computer-generated user interface 400 may include a condition or status communication and/or identifier (item 402). The condition or status communication and/or identifier (the item 402) may identify a condition or a status, for example associated with a system, device, and/or space of the domicile.

The computer-generated user interface 400 may also include one or more communications and/or identifiers associated with different types of residential data, as described herein. For example, the computer-generated user interface 400 may include a communication and/or identifier associated with a first set of residential data (item 404) and/or a second set of residential data (item 406).

In certain implementations, the first set of residential data (the item 404) and/or the second set of residential data (the item 406) identify a set of residential data associated with a system, device, and/or space, as described herein. For example, the first set of residential data (the item 404) may identify visual data associated with a basement, and/or the second set of residential data (the item 406) may identify audio data associated with the basement. The sets of residential data (e.g., the item 404, the item 406) may include a selectable indicator, for example to allow a user or operator to view and/or review the associated residential data.

In some embodiments, the computer-generated user interface 400 may also include one or more communications and/or identifiers associated an action or recommendation indicator (item 408), and/or one or more modification implementation indicators (item 410). In some embodiments, the action or recommendation indicator (item 408) provides a recommended action (e.g., a preventative action, a mitigative action, a maintenance action, a recommended component to add/remove/replace within the system or subsystem, etc.), for example to improve a condition of a system, subsystem, and/or space of a domicile (e.g., a sump pump of the domicile, etc.).

In certain embodiments, the modification implementation indicator (item 410) may facilitate implementing (e.g., performing, carrying out, etc.) the recommended action. In some implementations, the computer-generated user interface 400 may include the one or more diagrams, which may include one or more images and/or diagrams for implementing (e.g., performing, carrying out, etc.) the recommended actions.

As an illustrative example of an example scenario that may be implemented to provide the computer-generated user interface 400, a domicile or home of an individual may be provided with a mobile sensor system (e.g., the mobile sensor system 104, etc.), as described herein. As described herein, the mobile sensor system (e.g., the mobile sensor system 104, etc.) may be configured to obtain different types of residential data, which may be utilized to (i) determine a condition or a status of a system, device, and/or space of a domicile, and/or (ii) initiate an action (e.g., provide a recommendation for improving a condition of the domicile, etc.).

For example, the mobile sensor system (e.g., a portable or movable robot, a drone, etc.) may move about a portion of the domicile, for example to obtain residential data. As an illustrative example, the mobile sensor system may obtain visual data, for example indicating that a liquid has been identified in an area of a basement (e.g., in the corner of the basement, at an exterior wall in the basement, etc.). Further, the mobile sensor system may obtain audio data, for example indicating that no audio sound associated with a system or a device (e.g., a sump pump, etc.) is being detected in the basement.

Based upon the different types of residential data obtained, a condition or a status of a system, device, and/or space of the domicile may be determined. For example, using the visual data (e.g., indicating the present of liquid in the basement, etc.) and/or the audio data (e.g., indicating no sound associated with the sump pump is being detected, etc.), it may be determined that it is possible that a sump pump in the basement is non-operational (e.g., not operating, etc.).

As shown in the example computer-generated user interface 400, the condition of the device (e.g., potential non-operation of a sump pump, etc.) may be communicated to a user or owner associated with the domicile (e.g., the item 402). Further, the different types of residential data (e.g., used in determining the condition or status of the system, device, and/or space, etc.) may also be communicated to a user or owner associated with the domicile (e.g., the item 404, the item 406). In some scenarios, the data includes a selectable icon, for example to allow the user or owner to review and/or view the different types of associated residential data.

Based upon the determined condition and/or status of the device, an action may be initiated. For example, a recommendation may be communicated to the user or owner associated with the domicile, for example recommending that a technician be dispatched to examine the sump pump (the item 408), for example to prevent potential water damage to the domicile.

Further, the user or owner may be provided with one or more options to implement and/or perform the recommendation. For example, an option to schedule and/or coordinate a time for a technician to assess the sump pump may be communicated to the user or owner (the item 410). Advantageously, the computer-generated user interface 400 may be provided, for example, to allow an individual to assess a condition of their home (e.g., operating conditions, etc.), and/or to implement one or more preventative and/or mitigative actions, which may, for example, be used to prevent potential damage to the domicile and/or components thereof, prevent potential health and/or safety risks associated with current conditions, and/or to reduce resource consumption associated with current conditions.

### Exemplary Illustrative Examples

As a first non-limiting illustrative example, the systems and computer-implemented methods described herein may be implemented to (i) determine a condition or a status of a system, device, and/or space of a domicile, and/or (ii) initiate an action (e.g., provide a recommendation) for improving a condition of the domicile. For example, a sensor system or a mobile sensor system (e.g., an augmented robotic device, a movable robotic device, a drone, a camera or phone coupled with a movable device (for example a vacuum or robotic vacuum, or robotic lawn mower), a land-based rover coupled to an air-based drone or UAV, etc.) may be provided at a residence or domicile. The sensor system may be configured to controllably collect and/or communicate residential data, for example to be used in determining a condition or a status of a system, device, and/or space of the domicile.

For example, the sensor system may be provided at a space of the domicile (e.g., at a kitchen of the home, etc.). In some implementations, the sensor system is programmed to move about at least a portion of the domicile, for example to collect residential data. For example, the sensor system may be programmed to move about the kitchen in accordance with a schedule, for example to collect residential data when the kitchen is unoccupied (e.g., when an individual is at work, or away).

As described herein, the sensor system may move about the kitchen, for example collecting different types of residential data. For example, the sensor system may collect audio data associated with an operating condition of a device (e.g., an audio recording indicating that a fan of the refrigerator is operating or on, etc.). Further, the sensor system may collect visual data associated with a condition of a space (e.g., an image or video recording of the kitchen, indicating that the refrigerator and/or floor is sunk or angled, etc.). Yet further, the sensor system may collect other data associated with a device and/or a space (e.g., temperature data associated with an area in the kitchen surrounding the refrigerator, etc.). The information and/or data collected by the sensor system may be communicated to one or more systems or devices described herein (e.g., a residential system, etc.).

In certain implementations, the different types of residential data may be used to determine at least one of a condition or a status of a device or a system of the domicile. As described herein, a trained machine learning model may be used to process the different types of residential data to determine the condition and/or the status of a system, device, and/or space of the domicile. For example, using the residential data (e.g., the audio recording indicating that a fan of the refrigerator is running, the image of the kitchen indicating that the floor is angled, and/or the temperature information in the area surrounding the refrigerator), the trained machine learning model may determine (e.g., estimate, predict, etc.) that the refrigerator is leaking coolant, for example resulting in (i) the fan running to maintain a temperature of the refrigerator, (ii) moisture build-up in the floor/subfloor causing the floor to be angled, and/or (iii) the refrigerator to operate at elevated levels resulting in elevated temperatures surrounding the refrigerator.

Based upon this determination, the systems and computer-implemented methods described herein may be configured to initiate and/or provide an action instruction. For example, a recommendation to replace the coolant inlet/valve may be provided, for example as a preventative measure to prevent damage to the refrigerator and/or floor (e.g., as a result of coolant leaking from the refrigerator, etc.). Further, a recommendation to move the refrigerator may be provided, for example as a measure to mitigate any potential damage associated with the refrigerator potentially falling into and/or through the flooring. Yet further, a recommendation to turn off the refrigerator may be provided, for example as a measure to prevent and/or mitigate potential damage associated with additional moisture collecting in the flooring and/or additional heat provided at a wall adjacent the refrigerator.

Advantageously, and as shown via this first non-limiting illustrative example, the systems and computer-implemented methods described herein may be utilized to determine (e.g., estimate, predict, etc.) a condition and/or a status of a device and/or a space of a home (e.g., a refrigerator leaking coolant, a leaking valve or inlet, etc.), for example which otherwise would be difficult to detect and/or determine (e.g., due to an inability to access or assess the information, due to non-traditional correlations drawn between the information, etc.). Further, this determination may be used by an individual to assess a condition of their home (e.g., operating conditions, efficiencies, etc.), and/or to implement one or more preventative and/or mitigative actions, which may, for example, be used to prevent potential damage to the domicile and/or components thereof, prevent potential health and/or safety risks associated with current conditions, and/or to reduce resource consumption associated with current conditions.

As a second non-limiting illustrative example, the systems and computer-implemented methods described herein may be implemented to (i) determine a condition or a status of a system, device, and/or space of a domicile, and/or (ii) initiate an action (e.g., provide a recommendation) for improving a condition of the domicile. For example, a sensor system (e.g., a movable device, an executable application, etc.) may be provided at a residence or domicile. As described herein, the sensor system may be configured to selectively collect and/or communicate residential data, for example to be used in determining a condition or a status of a system, device, and/or space of the domicile.

For example, the sensor system may be provided at a space of the domicile (e.g., at a living room of the home, etc.). In some implementations, the sensor system is programmed to collect a first subset of residential data, and/or is inhibited or prevented from collecting a second subset of residential data. For example, the sensor system may be programed to collect motion data (e.g., light data, etc.), while the sensor system may be inhibited from collecting audio data and/or video data. The motion data may be utilized to determine an occupancy characteristic of the space. For example, the motion data may be utilized to determine that the living room is unoccupied, for example indicating that an individual is at work and/or away.

In certain implementations, based upon this determination, the sensor system may then be configured to collect a subset of residential data. For example, in response to determining that the living room is unoccupied, the sensor system may be programmed to collect (e.g., selectively, controllably, etc.) audio and/or visual data. In certain implementations, in response to determining that the living room is unoccupied (e.g., indicating that the home is unoccupied, etc.), the sensor system may be configured to move about a space of the domicile. For example, in response to determining that the living room (e.g., the domicile, etc.) is unoccupied, the sensor system may be configured to move to and/or about the basement (e.g., based upon a schedule, etc.), for example to collect one or more types of residential data.

As described herein, the sensor system may move about the basement, for example collecting different types of residential data. For example, the sensor system may collect audio data associated with an operating condition of a device (e.g., an audio recording indicating that a fan of an HVAC system is operating or on, etc.). Further, the sensor system may collect visual data associated with a condition or status of a device or a space (e.g., an image or video recording of the basement, showing a notification on a circuit breaker in the basement, etc.). Yet further, the sensor system may collect other data associated with a device and/or a space (e.g., moisture data associated with the basement space, etc.). The information and/or data collected by the sensor system may be communicated to one or more systems or devices described herein (e.g., a residential system, etc.).

In certain implementations, the different types of residential data may be used to determine at least one of a condition or a status of a device or a system of the domicile. As described herein, a trained machine learning model may be used to process the different types of residential data to determine the condition and/or the status of a system, device, and/or space of the domicile. For example, using the residential data (e.g., the audio recording indicating that a fan of the HVAC system is running, the image of the circuit breaker notification indicating that a circuit may have been impacted, and/or the moisture information in the basement), the trained machine learning model may determine (e.g., estimate, predict, etc.) that the sump pump is operating at less than optimal operating conditions (e.g., resulting in excess liquid remaining in the pump, etc.), for example (i) resulting in the fan running to maintain a temperature (e.g., moisture level, etc.) in the basement, (ii) resulting in additional resource consumption causing one or more breakers to trip, and/or (iii) resulting in elevated moisture levels in the basement.

Based upon this determination, the systems and computer-implemented methods described herein may be configured to initiate and/or provide an action instruction. For example, a recommendation to flush the sump pump may be provided, for example as a measure to improve the operating conditions of the sump pump. Further, a recommendation to add a dehumidifier to the basement may be provided, for example as a preventative and/or mitigative measure to maintain a moisture level in the basement (e.g., prevent potential damage associated with mold or bacteria, etc.). Yet further, a recommendation to add a backflow preventer to the sump pump may be provided, for example as a measure to prevent and/or mitigate potential damage associated with potential overflow of the sump pump (e.g., potential flooding or overflow damage in a wall or crawl space of the basement, etc.).

Advantageously, and as shown via this second non-limiting illustrative example, the systems and computer-implemented methods described herein may be utilized to determine (e.g., estimate, predict, etc.) a condition and/or a status of a device and/or a space of a home (e.g., a sump pump operating at less than optimal operating conditions, a sump pump needing maintenance or repair, etc.), for example which otherwise would be difficult to detect and/or determine (e.g., due to an inability to access and/or assess the information, due to non-traditional correlations drawn between the information, etc.). Further, this determination may be used by an individual to assess a condition of their home (e.g., operating conditions, efficiencies, etc.), and/or to implement one or more preventative and/or mitigative actions, which may, for example, be used to prevent potential damage to the domicile and/or components thereof, prevent potential health and/or safety risks associated with current conditions, and/or to reduce resource consumption associated with current conditions.

As a third non-limiting illustrative example, the systems and computer-implemented methods described herein may be implemented to (i) determine a condition or a status of a system, device, and/or space of a domicile, and/or (ii) initiate an action (e.g., provide a recommendation) for improving a condition of the domicile. For example, a sensor system (e.g., a movable device, a drone, a movable robot, an executable application, etc.) may be provided at a residence or domicile. As described herein, the sensor system may be configured to selectively and/or controllably collect and/or communicate residential data, for example to be used in determining a condition or a status of a system, device, and/or space of the domicile.

For example, the sensor system may be provided at a space of the domicile (e.g., at a living room of the home, etc.). In some implementations, the sensor system may be programmed to collect a first subset of residential data, and/or is inhibited or prevented from collecting a second subset of residential data. For example, the sensor system may be programed to collect motion data (e.g., light data, etc.), while the sensor system may be inhibited from collecting audio data and/or video data. As described herein, the motion data may be utilized to determine an occupancy characteristic of the space. For example, the motion data may be utilized to determine that the living room is unoccupied, for example indicating that an individual is at work and/or away.

In certain implementations, based upon this determination, the sensor system may then be configured to collect a subset of residential data and/or move about a space. For example, in response to determining that the living room is unoccupied (e.g., indicating that the home is unoccupied, etc.), the sensor system may be programmed to move about the kitchen (e.g., based upon a schedule, etc.) and/or to collect (e.g., selectively, controllably, etc.) different types of residential data, including audio and/or visual data.

As described herein, the sensor system may move about the kitchen, for example collecting different types of residential data. For example, the sensor system may collect audiovisual data associated with an operating condition or status of a device (e.g., an audio/video recording indicating that a dishwasher is off, but that liquid or fluid is flowing in the dishwasher, etc.).

In some implementations, based upon a subset of residential data, the sensor system may be configured to move about a space of the domicile (either inside or outside, i.e., move about a garage, yard or roof) and/or collect additional residential data. For example, based upon the audiovisual data indicating that the dishwasher is not running, but that liquid or fluid is flow in the dishwasher, the sensor system may be configured to move to the lower level of the home (e.g., fly, roll, traverse, etc.), for example to collect additional residential data.

As described herein, the sensor system may be configured to further move to one or more spaces and/or to collect additional residential data associated with a system, device, and/or space. For example, the sensor system may be configured to collect audio data associated with a condition of a device (e.g., an audio recording, indicating that a dehumidifier is operating or running in a lower level of the home). Further, the sensor system may be configured to move to another space (e.g., a basement, garage, yard, etc.), and collect additional audio data associated with a condition or status of a device and/or a space (e.g., an audio and/or video recording, indicating that no alarms or warnings are active and/or are on, etc.). The information and/or data collected by the sensor system may be communicated to one or more systems or devices described herein (e.g., a residential system, etc.).

In some embodiments, the different types of residential data may be used to determine at least one of a condition or a status of a device or a system of the domicile. As described herein, a trained machine learning model may be used to process the different types of residential data to determine the condition and/or the status of a system, device, and/or space of the domicile. For example, using the residential data (e.g., the audiovisual recording indicating that a dishwasher is not running or operating, but that fluid or liquid is flowing in the dishwasher, the audio data indicating that a dehumidifier is operating, and/or the audiovisual data indicating that no alarms or warnings are active or on), the trained machine learning model may determine (e.g., estimate, predict, etc.) that a sump pump is not operating, for example (i) resulting in water backup through the plumping system of the home (e.g., an into the dishwasher, etc.), (ii) resulting in an elevated moisture level in the home and/or a running of the dehumidifier, and/or (iii) as a result of a dead battery and/or loss of power of the alarm system of the sump pump.

Based upon this determination, the systems and computer-implemented methods described herein may be configured to initiate and/or provide an action instruction. For example, a recommendation to replace and/or repair a sump pump may be provided, for example as a measure to mitigate and/or potential damage associated with a backup of fluid in the plumbing system of the home. Further, a recommendation to add a backup alarm system and/or replace an existing alarm system associated with the sump pump may be provided, for example as a measure to mitigate and/or prevent potential damage associated with an occupant of the home not being aware of the operating status of the sump pump (e.g., due to the absence of an alarm or warning). Yet further, a recommendation to add a backflow preventer to the sump pump may be provided, for example as a measure to mitigate and/or prevent potential damage associated with potential overflow of the sump pump (e.g., potential flooding or overflow damage in a wall or crawl space of the basement, etc.).

Advantageously, and as shown via this third non-limiting illustrative example, the systems and computer-implemented methods described herein may utilize different types of residential data (e.g., which otherwise would be difficult to obtain, assess, and/or correlate, etc.) to determine (e.g., estimate, predict, etc.) a condition and/or a status of a device and/or a space of a home (e.g., a sump pump not operating, a sump pump needing maintenance or repair, etc.), for example which otherwise would be difficult to detect and/or determine (e.g., due to an inability to access and/or assess the information, due to non-traditional correlations drawn between the information, etc.). Further, this determination may be used by an individual to assess a condition of their home (e.g., operating conditions, efficiencies, etc.), and/or to implement one or more preventative and/or mitigative actions, which may, for example, be used to prevent potential damage to the domicile and/or components thereof, prevent potential health and/or safety risks associated with current conditions, and/or to reduce resource consumption associated with current conditions.

### Exemplary Machine Learning and Generative AI

As discussed elsewhere, some embodiments may utilize machine learning, generative artificial intelligence, or other advanced computing techniques. As such, in certain embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. The system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. The system may include multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for”or “step for”language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable, such as releasing a drone from a land-based robot or rover). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A computer-implemented method for initiating an action to improve a condition of a domicile, the computer-implemented method comprising:
receiving, from one or more mobile sensors, a plurality of different types of residential data associated with at least one component or space of the domicile, the one or more mobile sensors structured to move about at least a portion of the domicile, wherein the plurality of different types of residential data are collected by the one or more mobile sensors as the one or more mobile sensors move about the at least a portion of the domicile;
determining, by processing the plurality of different types of residential data using a machine learning model, at least one of a condition or a status of a device or a system of the domicile, and wherein the machine learning model is trained using historical data to establish at least one correlation between (i) a subset of the plurality of different types of residential data and (ii) at least one of a condition or a status associated with the device or the system of the domicile; and
initiating, using the machine learning model, the action to improve the condition of the domicile using the at least one of the condition or the status associated with the device or the system of the domicile.

2. The computer-implemented method of claim 1, further comprising:
providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.

3. The computer-implemented method of claim 1, wherein each of the plurality of different types of residential data include geolocation information, and wherein the at least one of the condition or the status of the device or the system of the domicile is determined using the geolocation information.

4. The computer-implemented method of claim 1, wherein each of the plurality of different types of residential data include time information associated with a collection of the residential data, and wherein the at least one of the condition or the status of the device or the system of the domicile is determined using the time information.

5. The computer-implemented method of claim 1, wherein the plurality of different types of residential data includes a first type of residential data and second type of residential data, the first type of residential data including audio data associated with an audio characteristic of the at least one component or space.

6. The computer-implemented method of claim 5, wherein the second type of residential data includes non-audio data, and wherein the machine learning model is trained using the historical data to establish a correlation between (i) the first type of residential data and the second type of residential data and (ii) the condition or the status associated with the device or the system of the domicile.

7. The computer-implemented method of claim 5, wherein the first type of residential data is collected by a first mobile sensor of the one or more mobile sensors as the first mobile sensor moves about a first portion of the domicile, and wherein the second type of residential data is collected by a second mobile sensor of the one or more mobile sensors as the second mobile sensor moves about a second portion of the domicile.

8. The computer-implemented method of claim 7, wherein the first mobile sensor is movable robot and the second mobile sensor is a drone, and wherein the first portion of the domicile is on a first level of the domicile and the second portion of the domicile is on a second level of the domicile different than the first level.

9. The computer-implemented method of claim 1, wherein the plurality of different types of residential data are associated with a space of the domicile, wherein the space is a kitchen of the domicile.

10. The computer-implemented method of claim 1, wherein the plurality of different types of residential data includes a first type of residential data, the first type of residential data including motion data associated with a space of the domicile, wherein the computer-implemented method further comprises:
determining, using the first type of residential data, that the space of the domicile is unoccupied; and
receiving a second type of residential data in response to the determination that the space of the domicile is unoccupied.

11. The computer-implemented method of claim 1, wherein the at least one of a condition or a status of the device or system is an operating condition of a sump pump.

12. The computer-implemented method of claim 1, wherein initiating the action comprises:
generating a recommendation for improving the condition of the domicile, the recommendation including at least one of a preventative action, a mitigative action, a component to add to a system of the domicile, or a component to replace in the system of the domicile.

13. The computer-implemented method of claim 1, further comprising:
receiving residential modification data, the residential modification data including information associated with a modification to the device or the system of the domicile; and
comparing the residential modification data with the action to verify a recommendation for improving the condition of the domicile.

14. The computer-implemented method of claim 13, further comprising:
generating, based upon the verification of the recommendation for improving the condition of the domicile, at least one insurance policy parameter; and
providing the at least one insurance policy parameter via a user interface.

15. A computer system for initiating an action to improve a condition of a domicile, the system comprising:
one or more memory devices having instructions stored thereon that, when executed by one or more processors, cause the one or more processors to perform operations comprising:
receiving, from one or more mobile sensors, a plurality of different types of residential data associated with at least one component or space of the domicile, the one or more mobile sensors structured to move about at least a portion of the domicile, wherein the plurality of different types of residential data include a first type of residential data and a second type of residential data, wherein at least one of the first type of residential data or the second type of residential data is collected by the one or more mobile sensors as the one or more mobile sensors move about the at least a portion of the domicile, and the other of the first type of residential data or the second type of residential data includes audio data associated with an audio characteristic of the at least one component or space;
determining, by processing the plurality of different types of residential data using a trained machine learning model, at least one of a condition or a status of a device or a system of the domicile; and
initiating, using the trained machine learning model, the action to improve the condition of the domicile using the at least one of the condition or the status associated with the device or the system of the domicile.

16. The system of claim 15, wherein the operations further comprise:
providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.

17. The system of claim 15, wherein each of the plurality of different types of residential data include geolocation information, and wherein the at least one of the condition or the status of the device or the system of the domicile is determined using the geolocation information.

18. The system of claim 15, wherein each of the plurality of different types of residential data include time information associated with a collection of the residential data, and wherein the at least one of the condition or the status of the device or the system of the domicile is determined using the time information.

19. A non-transitory computer readable medium comprising instructions stored thereon that, when executed by one or more processors, cause the one or more processors to perform operations comprising:
receiving, from one or more mobile sensors, a plurality of different types of residential data associated with at least one component or space of a domicile, the one or more mobile sensors structured to move about at least a portion of the domicile, wherein the plurality of different types of residential data including a first type of residential data and a second type of residential data different from the first type of residential data, wherein at least one of the first type of residential data or the second type of residential data is collected by the one or more mobile sensors as the one or more mobile sensors move about the at least a portion of the domicile;
determining, by processing the plurality of different types of residential data using a trained machine learning model, at least one of a condition or a status of a device or a system of the domicile, and wherein the trained machine learning model is trained using historical residential data to establish at least one correlation between (i) the first type of residential data and the second type of residential data and (ii) a condition or a status associated with the device or the system of the domicile; and
initiating, using the trained machine learning model, an action to improve the condition of the domicile using the at least one of the condition or the status associated with the device or the system of the domicile.

20. The non-transitory computer readable medium of claim 19, wherein the operations further comprise:
providing one or more instructions to the one or more mobile sensors configured to cause the one or more mobile sensors to move about the at least a portion of the domicile, the one or more instructions configured to control at least one of a time the one or more mobile sensors move about the at least a portion of the domicile, one or more locations of the domicile to which the one or more mobile sensors move, one or more times at which the one or more mobile sensors collect data while moving through the domicile, or one or more locations at which the one or more mobile sensors collect data while moving through the domicile.
